(19) United States
(12) Patent Application Publication
(10) Pub. No.: US 2026/0230327 A1
(43) Pub. Date: Aug. 6, 2026

(54) VERIFIABLE MULTI-AGENT COMPUTING

(71) Applicant: EQTY Lab AG, Zug (CH)

(72) Inventors: Yurko S. Jaremko, Toronto (CA); Benedict H.Y. Lau, Toronto (CA); Michael D. Ramos, Los Angeles, CA (US); Cameron J. Fyfe, Cornelius, OR (US); Jordan A. Taylor, McGaheysville, VA (US); Tyler Brink, Arvada, CO (US); Tucker McCoy, Gainesville, VA (US); Jonathan Dotan, Los Angeles, CA (US)

(21) Appl. No.: 19/635,568

(22) Filed: Mar. 31, 2026

Related U.S. Application Data
(63) Continuation-in-part of application No. 19/042,600, filed on Jan. 31, 2025.
(60) Provisional application No. 63/548,726, filed on Feb. 1, 2024.
(60) Provisional application No. 63/734,922, filed on Dec. 17, 2024.
(60) Provisional application No. 64/023,740, filed on Mar. 31, 2026.

(51) Int. Cl. H04L 9/32; G06F 21/62

(52) U.S. Cl. CPC H04L 9/3234; G06F 21/629

(57) ABSTRACT

Enforcing rules against agent-to-agent communications is disclosed. A policy decision point trigger is received. A set of checks associated with an agent-to-agent communication is performed. A determination is made that at least one check included in the set of checks fails. A remedial action associated with the agent-to-agent communication is taken.

### CROSS REFERENCE TO OTHER APPLICATIONS

This application is a continuation in part of U.S. patent application Ser. No. 19/042,600 entitled VERIFIABLE COMPUTING filed Jan. 31, 2025, which claims priority to U.S. Provisional Ser. No. 63/548,726 entitled VERIFIABLE COMPUTING filed Feb. 1, 2024 and claims priority to U.S. Provisional Ser. No. 63/734,922 entitled VERIFIABLE COMPUTE filed Dec. 17, 2024, each of which is incorporated herein by reference for all purposes.

This application also claims priority to U.S. Provisional Patent Application Ser. No. 64/023,740 entitled VERIFIABLE MULTI-AGENT COMPUTING filed Mar. 31, 2026 which is incorporated herein by reference for all purposes.

### BACKGROUND OF THE INVENTION

Confidential computing enables secure and reliable data processing by protecting sensitive information from unauthorized access during computation. This capability is particularly valuable in applications such as financial services, healthcare, and cloud computing, where maintaining data privacy is critical. Although confidential computing provides protections for sensitive data during processing, it does not inherently address the need for independent verification that the computation was performed. Furthermore, workloads in many domains, including artificial intelligence (AI) training and inference, continue to grow significantly in size and complexity. Therefore, there is a need for verifiable computing solutions that ensure computational integrity and support confidential computing as well as other computational contexts. This need extends to solutions that can be performed at scale and for large-scale workloads.

### BRIEF DESCRIPTION OF THE DRAWINGS

Various embodiments of the invention are disclosed in the following detailed description and the accompanying drawings.

FIG. 1 is a block diagram illustrating an embodiment of a hardware-based verification system for verifying compute.

FIG. 2 is a block diagram illustrating an embodiment of a trusted computing environment with digital notary.

FIG. 3 is a block diagram illustrating an embodiment of a confidential virtual machine with notary key.

FIG. 4 is a flow chart illustrating an embodiment of a process for verifying compute performed in a trusted computing environment.

FIG. 5 is a flow chart illustrating an embodiment of a process for generating a notary key for a trusted computing environment.

FIG. 6 is a flow chart illustrating an embodiment of a process for generating a notary key for a trusted computing environment that includes a GPU.

FIG. 7 is a flow chart illustrating an embodiment of a process for supporting verifiable computing using a digital notary.

FIG. 8 is a flow chart illustrating an embodiment of a process for supporting verifiable computing performed in a container.

FIG. 9 is a diagram of an embodiment of an issued verifiable credential.

FIG. 10 is a diagram of an embodiment of a signed computation statement.

FIG. 11 is a flow diagram illustrating an embodiment of a process for implementing a confidential AI model.

FIG. 12 is a flow diagram illustrating an embodiment of a process for performing verifiable and confidential inference.

FIG. 13 illustrates an example of an embodiment of a verification system.

FIG. 14 illustrates additional elements of a verifiable compute stack.

FIGS. 15-18 illustrate examples of user interfaces.

FIG. 19 illustrates an example of an identification of non-compliance.

FIG. 20 illustrates the tracing of attestations back to hardware.

FIG. 21 illustrates an example of an environment in which multiple agents are used.

FIG. 22 is a flow chart illustrating an embodiment of a process for evaluating an agent-to-agent communication.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The verification of compute including compute operations performed in secure environments is disclosed. For example, using the disclosed techniques and systems, a secure compute environment and its use in performing large-scale compute tasks can be verified using hardware-based cryptographic records. The verification process can include tracking and verifying specific inputs and the corresponding outputs that are determined by performing specific computational operations with the provided inputs. In some embodiments, the verified specific inputs include both the provided input parameters and the program code intended for execution within the compute environment, such as the corresponding computer code for executing specific computational operations. Using the disclosed techniques and systems, computational workflows with inputs that are among the largest and most challenging workloads available, such as workloads corresponding to artificial intelligence (AI) compute cycles for training and inference, can be traced and independently verified with their authentication tied to the underlying hardware. The disclosed approach, extending the functionality and usability of trusted computing environments, improves both security and performance, enabling verifiable computing to be conducted effectively at scale and for large-scale workloads.

In various embodiments, the disclosed verification techniques and systems utilize a hardware-based notary system with a notary key. The cryptographic notary key can be both generated within and linked to a trusted computing environment and its underlying hardware. For example, an attestation signed using a hardware-based cryptographic key can include the generated notary key and a representation of the secure environment, such as a hash of the virtual machine file system. In some embodiments, the trusted environment can correspond to a trusted execution environment of a central processing unit (CPU) and/or graphics processing unit (GPU). For example, the trusted environment can correspond to one or more encrypted and/or isolated areas of memory within one or more processors including within a CPU and/or GPU that is protected from unauthorized access or modification. Utilizing a trusted environment that supports confidential computing, the disclosed verification techniques and systems can be applied to both confidential and non-confidential compute. Moreover, one or more secure sessions can be created to allow for encryption and decryption of data moving between processors such as between one or more CPUs and/or GPUs. For example, a corresponding secure channel between a CPU and GPU can be verified by checking the signature of the GPU device and the GPU certificate authority. By utilizing hardware cryptographic modules and a notary subsystem, the verification of executed compute operations, including confidential and non-confidential compute operations, can be independently performed and tied to the underlying hardware-based cryptographic keys. As disclosed here, this approach allows for the compute verifications to be performed at scale including for data operation and workflows that would otherwise be unverifiable.

In various embodiments, the verification of different attributes and/or properties of computing can be performed and can correspond to different proofs including a proof of confidentiality, a proof of environment, a proof of correctness, a proof of computation, and a proof of governance, among others. For example, with proof of confidentiality, verifiers can ensure that confidential information involved in the computation remains confidential during computation. With proof of environment, verifiers can confirm that the computation was executed in their expected environment. For proof of correctness, verifiers can check that the inputs (including the algorithm and data) and outputs are as expected and were executed as expected. Proof of computation allows verifiers to confirm that the amount of work expensed in the computation is as expected, such as based on metrics that are collected, signed, and emitted from the trusted computing environment. With proof of governance, verifiers can confirm that the implemented governance controls have passed at runtime, that the computation was policy-compliant, and/or that the data quality of produced artifacts is assured. In various embodiments, the proofs generated are non-interactive persistent proofs. For example, the generated proofs can be non-interactive cryptographic proofs that do not require interaction between the prover and the verifier and can remain valid and verifiable indefinitely. Moreover, the proofs may be held private until their disclosure or use is needed, such as for scenarios related to the verification of a completed computation.

In various embodiments, the disclosed techniques and systems can be applied to computing applications including confidential (and non-confidential) computing applications that are performed at scale and for large-scale workloads. Small workloads might include hundreds of thousands to millions of parameters for a neural network. For more complex tasks, billions of parameters can be utilized. Moreover, existing models can even require over 1 trillion parameters. Using the disclosed solutions, verifiable compute can be performed for computationally-intensive tasks that are at and even beyond these limits. Additionally, the disclosed verifiable computing solutions are applicable for different aspects of the AI pipeline and landscape and allow for new models of trust particularly for AI training and inference. Moreover, the corresponding provided proofs are each auditable and can be persistent and/or performed non-interactively and independently. In the context of AI training, verifiable computing can provide proof of lineage for models and instruction fine-tuning. As additional examples, for AI interference, verifiable computing can provide proof of deployed models and parameters; for AI benchmarks, verifiable computing can provide proof that AI systems are performant; for AI governance, verifiable computing can provide proof that AI processes are compliant; for AI privacy, verifiable computing can provide proof that AI models and data remain confidential; for AI safeguards, verifiable computing can provide proof that AI guardrails are implemented; for AI financial operations, verifiable computing can provide proof that AI workloads stay within budget; and for AI builds, verifiable computing can provide proof that AI systems are auditable. Other proofs not listed, including ones usable for auditing and other assurances, are applicable as well, and can further apply to additional contexts other than AI training and inference.

In various embodiments, the disclosed verifiable compute techniques and systems enable AI training and inference that can be trusted by its users. With respect to AI models, a secure virtual machine can download a base AI model and verify the download using a hash of the model file. The model can be a private model with a public and verifiable hash but where access is private and closely guarded using an access token. The model can be signed by the disclosed notary key guaranteeing that the exact version was downloaded by the auditable source code. The model and its hash can be used for input in later steps in an AI workflow.

In some embodiments, with respect to AI data preparation, a confidential virtual machine with a digital notary can access data such as instruction fine-tuning data and/or retrieval-augmented generation (RAG) data. For example, the data can be accessed from a known source such as a public repository or shared read-only data source. The confidential virtual machine can verify the data against an expected hash that is contained in the audited source code. Processing of the data can be performed, and the output can be signed with the notary key. The output can then be used as input for later steps of an AI workflow.

In some embodiments, with respect to RAG embedding creation, a secure and confidential virtual machine with a digital notary can perform a secure boot, load its data, check that the data matches its expected hash, and place the associated GPU into a confidential computing mode using the CPU's trusted execution environment. Compute-intensive work for generating RAG embeddings, which require text embedding to be created using an embedding model, can then be performed. The output can be signed, such as with the disclosed notary key, and can be used for verified inference.

In some embodiments, verifiable compute is applied to model training and fine-tuning, compute-intensive tasks that often use a cluster of powerful GPUs. The same virtual machine, or another verified virtual machine with a similar setup, can begin the long-running training job using GPUs configured in a confidential computing mode. The resulting model is signed and ready to be used for inference. This trained model is fully auditable end-to-end and is no longer a black box.

In some embodiments, verifiable compute is applied to AI model evaluation and benchmarking. For example, a standard or custom benchmarking suite can be used to evaluate the performance of a custom model or a model that's being used with a RAG dataset. This approach involves running a large amount of inference. The proof of the inference results can be included in a verifiable chain of data and computation, such as signed computation statements. In various embodiments, and similar to the other verifiable workloads, a secure virtual machine is provisioned with GPUs in a confidential computing mode, the data is loaded, checking that it matches the expected hash, and the long-running benchmarking task can be run using the GPUs. The resulting report is signed and available for future auditors to verify without having to stand up the original model and rerun the benchmark.

In some embodiments, verifiable compute is applied to AI inference tasks. For example, using the disclosed techniques and systems, a verified and trustworthy model can now be used for verifiable inference, allowing the model to be run and accessed by users verifiably. A secure virtual machine and GPUs can be provisioned. As the model services chat requests and runs inference, each request can utilize a certificate providing one or more proofs. Proof of correctness guarantees the specific model that was used. Proof of hardware confidentiality, combined with auditable source code, guarantees that the contents of the chat session remain confidential. Proof of environment can be used to verify claims such as a claim that the model runs in a data center powered by renewable energy. In some embodiments, this proof is a proof of computation residency, which can be augmented with signed renewable energy audits of a utility supplying a data center. Proof of governance can ensure that all policies were met at runtime. As one example, users of AI chat sessions can be certain that they are interacting with the expected server by verifying that the SSL certificate is derived from the virtual machine's notary key and rooted in a validated chain of trust. Moreover, confidential inference can also be guaranteed because the virtual machine's source can be audited to verify that it doesn't release any of the user's input data externally, for example, processing it only inside the encrypted and confidential virtual machine with the GPU in a confidential computing mode.

In some embodiments, the proof of environment is provided from the CPU and/or GPU. Proof of environment from the CPU can correspond to a persistent proof of the genuine origin of the CPU from its manufacturer or vendor (such as from Intel, AMD, or another origin source), the type of CPU, the features enabled in the environment, and/or which security firmware was enabled. In various embodiments, the CPU may not directly attest to measurements of the open virtual machine firmware (OVMF), kernel, and/or initial RAM disk by default, however, the CPU's participation in integrity measurement architectures allows for secure software attestation of these components. This proof allows auditors to prove the integrity of the genuine CPU hardware and environment. With respect to a GPU, proof of environment from the GPU can correspond to a persistent proof of the genuine origin of the GPU (such as from NVIDIA or another origin source), the type of GPU, the features enabled in the environment, which firmware was enabled, and/or corresponding measurements including hardware and/or firmware measurements. This proof allows auditors to prove the integrity of the genuine GPU hardware and environment.

In some embodiments, the proof of confidentiality is provided from the CPU and/or GPU. Proof of confidentiality from the CPU can correspond to a persistent proof that the file system has not been modified after boot by the CPU. This proof allows auditors to prove that the system did not leak information and remained secure throughout processing. With respect to a GPU, proof of confidentiality from the GPU can correspond to a persistent proof that confidential computing mode has been enabled on the GPU, which ensures that the VRAM is encrypted and only accessible to the current virtual machine. This proof allows auditors to prove that the system did not leak information to the guest or other virtual machines and remained secure throughout the processing.

In various embodiments, verifiable compute can be used to implement guardrails and safeguards. For example, verifiable compute can ensure that at runtime safeguards such as data privacy checks, model alignment, and content moderation are applied. Verifiable compute can ensure and provide evidence that only approved measures were implemented. Examples include verifiably removing personally identifiable information (PII) with approved algorithms before AI training and verifiably triggering approved safety messages to moderate inference. More complex tokenization workflows can verifiably ensure that only approved programs are used to tokenize sensitive information before inference and re-tokenize data after inference. Additionally, an array of verifiable governance measures can be taken in clean rooms to guarantee and document that only the approved prompts are brought into an AI clean room, differential privacy measures are properly configured, and aggregated inference is in line with the agreed upon standards.

In some embodiments, verifiable compute is applied to address RAG systems that reference specific sources as part of a prompt response. With the disclosed proving environment, integrity can be added to each of the specific references by citing hash-identified original sources. User clients can verify that they are only interacting with the expected server and that the inference is citing specific, authenticated data sources with lineage. In various embodiments, the RAG proof is accomplished starting with verifiable creation of the embedding and metadata databases from data sources. The metadata database can be indexed in a particular way that supports hash-addressing of specific data ranges, providing proofs of inclusion against a root hash, which can be used as a version identifier of the RAG corpus. Upon querying, prompt responses can incorporate these verifiable referencing data, providing users with a highly granular certificate of authenticity for the response they receive. When the disclosed verifiable compute is used as a secure co-processor for a smart contract on a public blockchain, the disclosed techniques and systems can be used to ensure automated royalty payments to contributors of a dataset as the data is consumed. For example, when an AI agent consumes data from a prepared RAG dataset, the contributors of the dataset can automatically receive royalty payments based on a signed computation statement and without the need for additional trusted third parties to facilitate or process the transaction.

In addition to providing proofs of inclusion, such as to verify that a particular element exists within a dataset of a performed computation, proofs of exclusion can be used to verify that a particular element does not exist in the dataset of a performed computation. For example, the identified input to a computation can be compared against specific elements to determine whether those specific elements were included or excluded from the performed computation. In some embodiments, the specific elements are compared against input to a computation to determine inclusion or exclusion using unique cryptographic hashes. The generated proofs of exclusion are valuable in verifying that specific data elements were not used during computing operations and/or sessions. For example, a proof of exclusion can be generated to assure that personally identifiable information was not used in training an AI model. As another example, using proofs of inclusion and/or exclusion, verification can be performed on whether an embedding has been retrieved and included or not included in a payload for a model. Used separately, together, or in combination with other proofs, proofs of inclusion and proofs of exclusion can be used to ensure compliance with data privacy policies, data sharing agreements, regulatory requirements, intellectual property rights, and/or other computing practices.

In some embodiments, a notary key of a trusted computing environment is generated. For example, a notary key based on random numbers is generated within a trusted execution environment such as a hardware-based secure enclave. The notary key can be a private-public key pair such as an asymmetric elliptic-curve key pair. As part of the generation process, the public component of the notary key can be included in a signed attestation of the trusted execution environment. The signed attestation proves that the notary key was created in the corresponding trusted execution environment. In some embodiments, a statement representing an input and an output of the trusted computing environment is generated. For example, an input is presented to the trusted computing environment which produces a corresponding output. The input can include program code such as executable code that is executed within the trusted computing environment. In some embodiments, the input is executed within a trusted execution environment and within the trusted computing environment identified by the notary key. Other examples of input can include program arguments including arguments used by a program code specified by an input. In some embodiments, a one-way hash of the different inputs and outputs can be used in the signed statement and allows for the option to keep the actual inputs and outputs unpublished and/or undisclosed until needed. In various embodiments, the disclosed verifiable computing techniques and systems can be applied to both confidential computing and non-confidential computing scenarios. For example, when a workflow calls for confidential computing, confidential compute that has been performed can be verified using a signed statement that references the corresponding confidential compute operations. Similarly, when a workflow does not require confidential computing, the compute can be performed non-confidentially outside of a confidential compute mode. The performed non-confidential compute can be verified using a signed statement that references the corresponding non-confidential compute operations.

In some embodiments, the statement is signed based on the notary key. For example, using the notary key that was created in a corresponding trusted execution environment, the statement is cryptographically signed. In various embodiments, the signature corresponds to various proofs such as proofs of confidentiality, environment, correctness, computation, and/or governance, among others. The proofs generated can include non-interactive persistent proofs. For example, the generated proofs can remain valid and verifiable indefinitely and can be verified independently by a verifier without interaction with the prover. In some embodiments, the signed statement is exported outside the trusted computing environment. For example, the signed statement can be provided outside of the trusted computing environment allowing the statement to be verified. The statement can be provided by publishing the statement to a medium (whether public or private) such as a public or private blockchain, website, or repository, etc. In some embodiments, the signed statement is stored such as on a public blockchain for later retrieval and verification. The signed statement may also be stored privately and securely, with the option to release the signed statement to a broader audience if appropriate. By exporting the signed statement, the computation and/or related computational operations of the statement can be verified independently. In some embodiments, when provided publicly, the signed statement can be further verified independent of the original trusted computing environment with the assistance of third parties, such as for independent auditing purposes. As another example, when the signed statement is provided publicly, such as on a public blockchain, the disclosed verifiable compute can be used as a secure co-processor for a smart contract on the public blockchain. The secure contract can independently and automatically verify the performed computations, initiating automated follow-up processing such as the automatic payment of royalties to the appropriate parties. In some embodiments, the verification is tied to the original signed attestation of the trusted execution environment, which is a hardware-based attestation.

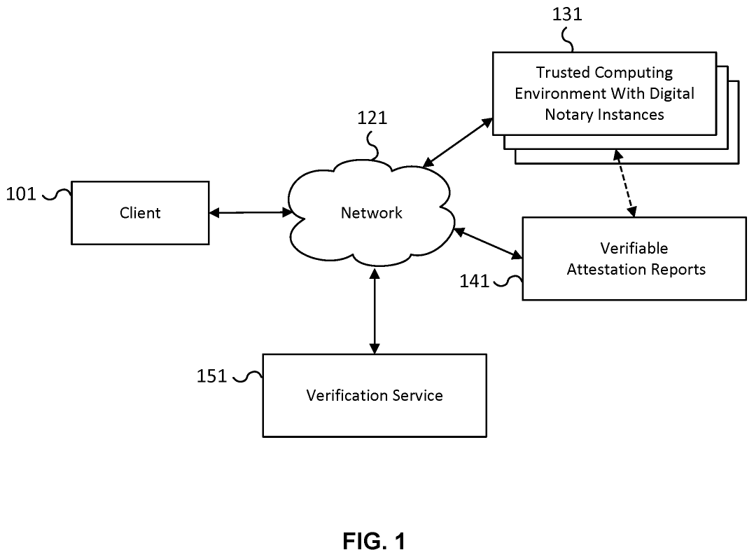

FIG. 1 is a block diagram illustrating an embodiment of a hardware-based verification system for verifying compute. In the example shown, trusted computing environment with digital notary instances 131 can securely and efficiently trace and perform compute at scale and for large workloads. The compute operations performed by trusted computing environment with digital notary instances 131 generate verifiable attestation reports 141, which can be publicly or privately exported and verified by client 101 using verification service 151. The compute operations performed can include compute performed with one or more instances of trusted computing environment with digital notary instances 131 configured in a confidential or non-confidential computing mode. Client 101, trusted computing environment with digital notary instances 131, verifiable attestation reports 141, and verification service 151 are communicatively connected to one another via network 121. Network 121 can be a public or private network. In some embodiments, network 121 is a public network such as the Internet. In various embodiments, clients such as client 101 can correspond to automated or manually initiated clients for initiating compute tasks using trusted computing environment with digital notary instances 131. For each verifiable compute task, trusted computing environment with digital notary instances 131 generates a signed statement as verifiable attestation reports 141. Using a signed statement, the performed compute can be verified using a verification service such as verification service 151.

In some embodiments, client 101 is an example network client device for interfacing with trusted computing environment with digital notary instances 131, verifiable attestation reports 141, and verification service 151. For example, client 101 can be used to initiate verifiable compute including compute operations using trusted computing environment with digital notary instances 131. Additionally, client 101 can be used to retrieve verifiable attestation reports 141 generated from performing confidential or non-confidential compute tasks. For example, using retrieved verifiable attestation reports 141, client 101 can verify the performed compute using verification service 151. In various embodiments, client 101 can be an automated or manual client, such as an automated or manual client to perform the verification of compute, whether performed in a confidential or non-confidential computing mode of trusted computing environment with digital notary instances 131. For example, an automated version of client 101 can be used to perform verifiable compute at scale.

In some embodiments, trusted computing environment with digital notary instances 131 corresponds to one or more instances of a trusted computing environment with a digital notary for use in verifying performed compute. In some embodiments, each instance corresponds to a secure virtual machine operating with one or more hardware-based trusted execution environments. The trusted computing environment can utilize a combination of one or more CPUs and/or GPUs with encrypted and/or isolated areas of memory for performing confidential computing on sensitive data. The trusted computing environment can correspond to various computing architectures such as a single tenant with a single GPU, a single tenant with multiple GPUs, and multiple single tenants with single GPUs, among others. To verify compute performed using trusted computing environment with digital notary instances 131, each instance can generate signed statements corresponding to performed compute operations and/or compute states. For example, a statement corresponding to a compute operation is signed using a cryptographic notary key that links the compute operation to a specific trusted computing environment. In some embodiments, the cryptographic notary key is generated and based on a hardware-based cryptographic key tied to the trusted execution environment. By utilizing a hardware-based cryptographic notary key, the compute can be performed, traced, and verified both at scale and for large-scale workloads.

In some embodiments, instances of trusted computing environment with digital notary instances 131 can function as verifiable gateways with corresponding generated persistent proofs of communication. For example, when a third-party service is needed as part of a workflow, the verifiable gateway functionality provides persistent proofs of communication with third parties such as for accessing third-party services including API services. The verifiable gateway can help to maintain and/or ensure the integrity of a workflow including for workflows that rely on third-party services. In some embodiments, an instance of trusted computing environment with digital notary instances 131 functioning as a verifiable gateway acts as a trusted witness to network traffic, including TLS traffic, between itself and a third-party server. For example, certificates of third-party servers can be validated and a confidential guarantee that the trusted computing environment and associated trusted execution environment is secure and authentic is provided. Generated persistent proofs, which can be independently and retroactively verified, can be used to verify attestations that a connection is valid including that session keys for the connection have not been leaked. In some embodiments, these proofs can be used to confirm that a connection was not spoofed at the time of communication.

In some embodiments, verifiable attestation reports 141 correspond to specific attestations based on a trusted computing environment. The specific attestations can be used to trace the exact elements provided as input and the corresponding output generated during a compute session for a specific trusted computing environment. In some embodiments, verifiable attestation reports 141 can correspond to one or more public or private databases or data stores such as a public blockchain or private database. For example, one or more of the individual reports of verifiable attestation reports 141 can be published and retrieved to independently verify the described and attested to compute. In some embodiments, verifiable attestation reports 141 are registered on-chain to create an independent block-time stamp on systems such as the Hedera Consensus Service (HCS). In some embodiments, verifiable attestation reports 141 utilize hashes for both inputs and outputs and include within the inputs executable compute operations such as the program code executed on the other inputs to generate the outputs. By hashing the inputs and outputs, the security of the hashed data is significantly improved. For example, data integrity for the input and output can be ensured and the input and output can be protected against data tampering. Moreover, the actual hashed data can remain hidden and secure and only revealed if necessary, such as to confirm knowledge of the original source data used to generate the hashed data. Similarly, individual attestation reports of verifiable attestation reports 141 can be kept confidential and private. The private reports can be optionally made public, when appropriate, such as to allow for public verification by third parties.

In some embodiments, verification service 151 is a service for verifying verifiable attestation reports 141 using trusted authorities and a verification infrastructure. Although the verification infrastructure may be a private infrastructure, in some embodiments, at least a portion of the infrastructure is a public verification infrastructure. For example, verifiable attestation reports 141 can be signed by a notary key that is based on a hardware-based cryptographic key. The underlying hardware-based cryptographic key can be further backed by public key infrastructure to confirm its ownership. For example, a hardware-based cryptographic key can be authenticated by a public authority such as a trusted certificate authority or trust authority. In various embodiments, verification service 151 can be used to ensure that compute sessions attested by verifiable attestation reports 141 occurred in the manner described, such as the specified inputs were provided to generate the specified outputs. When verifiable attestation reports 141 are kept private, the verification can be performed without any public disclosure of verifiable attestation reports 141.

Although single instances of some components have been shown to simplify the diagram of FIG. 1, additional instances of any of the components shown in FIG. 1 may exist. For example, client 101 is an example client and many more additional clients can exist. Similarly, trusted computing environment with digital notary instances 131 can correspond to multiple different instances of a trusted computing environment with digital notary and can include distributed instances. Verifiable attestation reports 141 may correspond to multiple different reports that can be distributed to different public or private stores, databases, and/or other distribution mediums. Although a single verification service 151 is shown, in various embodiments, verification service 151 can be implemented by one or more different and/or overlapping verification services. In some embodiments, components not shown in FIG. 1 may also exist and/or the network configuration of the included components may differ from what is shown.

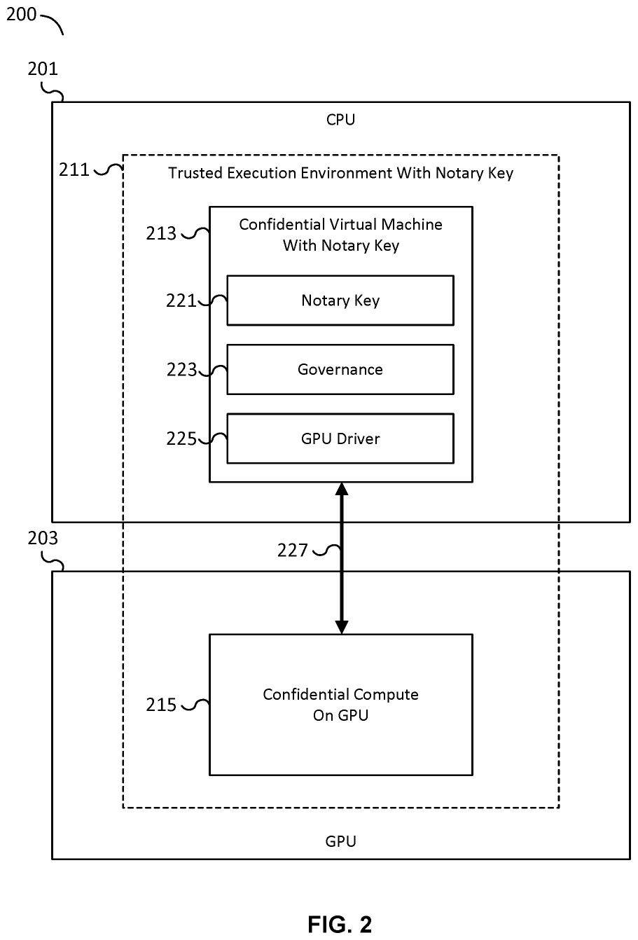

FIG. 2 is a block diagram illustrating an embodiment of a trusted computing environment with digital notary. In the example shown, trusted computing environment with digital notary 200 includes CPU 201 and GPU 203. Leveraging secure portions of CPU 201 and GPU 203, trusted execution environment with notary key 211 is capable of performing computing including confidential computing. Trusted execution environment with notary key 211 includes confidential virtual machine with notary key 213, which communicates over secure channel 227 to perform confidential compute on GPU 215. As shown in FIG. 2, confidential virtual machine with notary key 213 includes notary key 221, governance 223, and GPU driver 225. In some embodiments, trusted computing environment with digital notary 200 corresponds to an instance of a trusted computing environment that utilizes a hardware-based notary key to sign statements attesting to performed computing including confidential and non-confidential computing. In some embodiments, trusted computing environment with digital notary 200 is an instance of trusted computing environment with digital notary instances 131 of FIG. 1.

In some embodiments, CPU 201 and GPU 203 are hardware processing units configured for computing and include computing modes for performing confidential computing. For example, CPU 201 and GPU 203 include encrypted and/or isolated areas of memory that are only accessible within a trusted execution environment such as trusted execution environment with notary key 211. In various embodiments, CPU 201 and GPU 203 include hardware-based cryptographic keys (not shown) tied to the trusted execution environment functionality that can be authenticated such as with trusted root authorities. To create an isolated and trusted computing environment, trusted execution environment with notary key 211 provides a security layer by isolating compute that is performed confidentially. This isolation ensures that the data and code executed within trusted execution environment with notary key 211 cannot be tampered with and accessed without proper authorization.

In some embodiments, trusted execution environment with notary key 211 includes a cryptographic attestation module (not shown). This hardware-based attestation module can provide proof that a particular virtual machine with a specific configuration, such as confidential virtual machine with notary key 213, is booted securely including by authenticating the virtual machine file system.

In the embodiments shown, confidential virtual machine with notary key 213 is an example instance of a secure virtual machine for performing computing that can be verified. Confidential virtual machine with notary key 213 has its own generated notary key 221 for signing both a representation of confidential virtual machine with notary key 213 and statements describing its performed compute sessions. In some embodiments, the compute sessions are confidential compute sessions. In some embodiments, multiple different instances of a confidential virtual machine with notary key 213 can exist and be configured, for example, for different virtual hardware and/or software configurations.

In some embodiments, confidential virtual machine with notary key 213 includes multiple components and/or modules such as notary key 221, governance 223, and GPU driver 225. Additional components and/or modules can exist but are not shown. Notary key 221 corresponds to a generated cryptographic key that is unique to confidential virtual machine with notary key 213. In various embodiments, notary key 221 is signed and/or attested to by one or more hardware cryptographic keys, such as by a hardware cryptographic key associated with CPU 201 and/or trusted execution environment with notary key 211. Similarly, notary key 221 can be additionally signed by a hardware cryptographic key associated with GPU 203. In some embodiments, notary key 221 is included in one or more hardware-based attestation reports that can be used to verify that notary key 221 was generated within the secure environment of confidential virtual machine with notary key 213. Included in the attestation report can be a representation of confidential virtual machine with notary key 213, such as a computed hash of the virtual machine file system. An attestation report attesting to notary key 221 and a representation of the trusted computing environment (not shown) can be used to help verify confidential computing performed by confidential virtual machine with notary key 213. In various embodiments, the private key component of notary key 221 is secured, such as in a secret store or secure enclave, ensuring that the private key component remains confidential and protected from unauthorized access. The public key component of notary key 221 can be published and shared and functions as a public key component of an asymmetric key pair.

In some embodiments, communication with an external party can utilize notary key 221. For example, an SSL certification can be generated using notary key 221. This allows an external party to authenticate its connection to confidential virtual machine with notary key 213 by retrieving an attestation report and comparing the report to the SSL certificate. This ensures that the external party is communicating securely to the intended system and confidential environment, allowing external actors to safely interact with longer running processes across the trust boundary.

In some embodiments, governance 223 corresponds to an example of one form of compute performed within trusted execution environment with notary key 211. For example, governance 223 can include the performance of compute operations to confirm that certain controls were passed at runtime and that the associated computation is policy-compliant and/or that the data quality meets a certain standard. In some embodiments, governance 223 corresponds to the performance of specified governance computational operations and results in the generation of a signed governance statement that can be verified. The signed governance statement, signed using notary key 221, can include the signing of all input and output associated with governance 223 such as all input and output files, parameters, and/or program code. The signed governance statement signed using notary key 221 corresponds to a proof of governance and can be verified. In various embodiments, with proof of governance generated by governance 223, verifiers can confirm that the implemented governance controls have passed or failed at runtime, that the computation was policy-compliant, and/or that the data quality of produced artifacts are assured. In some embodiments, the signed governance statement corresponds to a non-interactive persistent proof.

In some embodiments, GPU driver 225 can correspond to GPU firmware that is used to sign notary key 221 and to set up and/or confirm a secure connection between CPU 201 and GPU 203. For example, GPU driver 225 can be used at least in part to generate a hardware-based attestation report based on a GPU hardware cryptographic key. The generated GPU-based attestation report can include notary key 221 and can be used for signatures associated with notary key 221, such as signatures associated with governance 223. In some embodiments, GPU driver 225 is used to help establish secure channel 227 to allow programs and workload to be confidentially executed using GPU 203. The confidential compute is offloaded to GPU 203 as confidential compute on GPU 215 via encrypted transfers between CPU 201 and GPU 203 via secure channel 227. Although not shown in FIG. 2, in some embodiments, the compute performed on GPU 203 uses a non-confidential compute mode and the connection between CPU 201 and GPU 203 may not be a secure connection. Similarly, the compute offloaded to GPU 203 may be non-confidential compute.

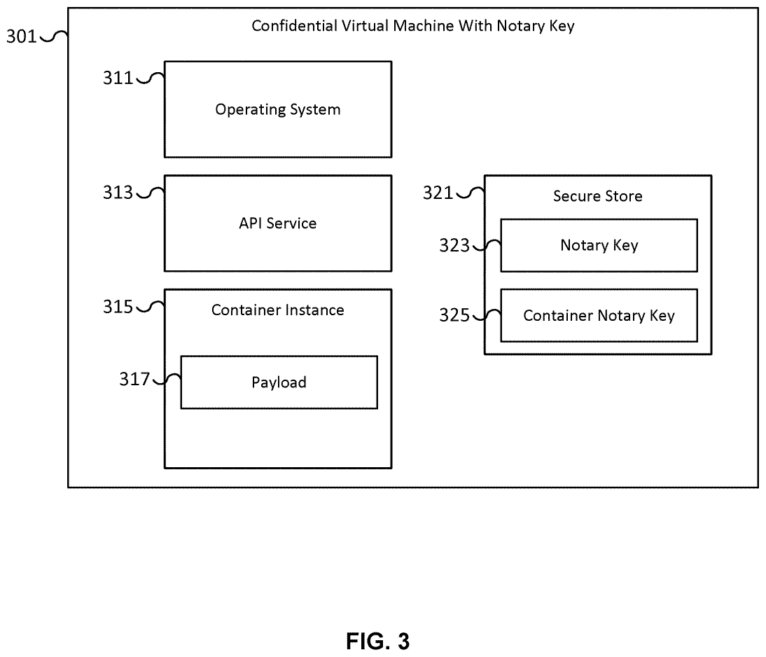

FIG. 3 is a block diagram illustrating an embodiment of a confidential virtual machine with notary key. In the example shown, confidential virtual machine with notary key 301 supports containers and includes operating system 311, application program interface (API) service 313, container instance 315, and secure store 321. Container instance 315 is an example of one instance of a container and includes payload 317. Secure store 321 includes notary key 323 and container notary key 325. In the example shown, container notary key 325 is a type of notary key specifically for container instance 315. In various embodiments, confidential virtual machine with notary key 301 can include additional containers (not shown) and each would have a corresponding container notary key that would be stored in secure store 321. The support for containers and a container notary key allows a more flexible and modular architecture that supports dynamic job loading. In some embodiments, confidential virtual machine with notary key 301 is confidential virtual machine with notary key 213 of FIG. 2 and runs within a trusted execution environment such as trusted execution environment with notary key 211 of FIG. 2. In some embodiments, notary key 323 is notary key 221 of FIG. 2.

In some embodiments, operating system 311 is an installed operating system for a configured virtual machine. Operating system 311 may run on virtualized hardware provided by the virtual machine of confidential virtual machine with notary key 301. An image of operating system 311 can be hashed and included in an attestation for confidential virtual machine with notary key 301.

In some embodiments, API service 313 is an API service for securely interfacing with confidential virtual machine with notary key 301 and containers loaded by confidential virtual machine with notary key 301. For example, using API service 313, a client can provide a payload such as payload 317 for use with container instance 315. The provided payload may be encrypted in transit and may require container notary key 325 to access the unencrypted data. In some embodiments, API service 313, utilizing container notary key 325, allows data to be securely transferred to and from container instance 315. In this manner, the data can be securely transported and only unencrypted when accessed within a trusted computing environment.

In some embodiments, container instance 315 is a container for running an isolated environment separate from other container instances. Container instance 315 can include the necessary code, runtime, libraries, state, and other tools for computing (such as for confidential computing, if appropriate) while also being lightweight in size and more resource efficient than utilizing an entire virtual machine. Container instance 315 utilizes its container notary key 325 rather than directly using notary key 323 and can receive payloads such as payload 317 via API service 313. In some embodiments, container instance 315 corresponds to a container system within the root file system with a limited set of API function calls to manage workloads, allowing other container instances to host different workloads even after confidential virtual machine with notary key 301 has booted. In some embodiments, the root file system includes an endpoint, accessible only to the container instances such as container instance 315, that facilitates content signing with the appropriate container notary key. This design enables containers to participate in the signing process without direct access to the private notary key, enhancing security and integrity.

In some embodiments, each instance of a container, such as container instance 315, generates its own notary key such as container notary key 325 that is signed by notary key 323. Container notary key 325 is signed along with a representation of container instance 315, such as the container's hash and relevant metadata. This creates a secure chain of trust back to the hardware-based cryptographic key. In various embodiments, container notary key 325 is attested to by notary key 323 and container notary key 325 is scoped specifically to container instance 315. This scoping prevents two otherwise unrelated jobs from producing proof artifacts signed by the same notary key.

In some embodiments, secure store 321 is a trusted secure store for safely storing private cryptographic keys used by confidential virtual machine with notary key 301. Secure store 321 may be a secret store and may correspond to secure and isolated memory within a trusted execution environment, securely storing notary key 323 and container notary key 325. In various embodiments, private key components of notary key 323 and container notary key 325 never leave secure store 321, and instead requests are provided via API service 313 to perform cryptographic operations such as signing and decryption with the secured keys. For example, container instance 315 may utilize API service 313 to sign and decrypt using container notary key 325 without container notary key 325 ever leaving secure store 321. Similarly, neither notary key 323 nor container notary key 325 are directly readable from container instance 315.

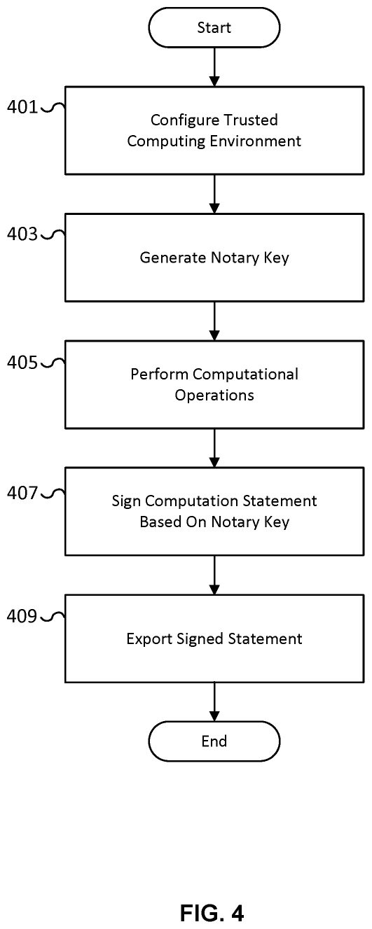

FIG. 4 is a flow chart illustrating an embodiment of a process for verifying compute performed in a trusted computing environment. Using the process of FIG. 4, compute, including confidential compute, can be traced and verified effectively at scale and for large-scale workloads with verification tied to trusted authorities and hardware-based cryptographic keys. Moreover, the performed compute can include workflows with inputs that are among the largest and most challenging workloads available, such as workloads corresponding to AI compute cycles for training and inference. In some embodiments, the process of FIG. 4 is performed by a trusted computing environment with a digital notary such as an instance of trusted computing environment with digital notary instances 131 of FIG. 1 using a signed attestation such as an attestation report of verifiable attestation reports 141 of FIG. 1. In some embodiments, the verification of the signed attestation utilizes a public authentication infrastructure such as via verification service 151 of FIG. 1.

At 401, a trusted computing environment is configured. For example, a confidential virtual machine is created with the appropriate virtual environment. In some embodiments, the underlying hardware must support trusted computing features including a secure store and hardware-based cryptographic keys. The configuration can include enabling trusted execution features and configuring the operating system to support the trusted hardware. In various embodiments, a trusted execution environment is set up along with cryptographic services including a secure secret store such as a hardware security module for storing private keys securely. In various embodiments, the runtime environment is configured including configuring a secure boot process, trusted software components, and signed applications and operating system kernels, among other components. In some embodiments, the trusted computing environment is configured to support both virtual machines and containers.

At 403, a notary key is generated. For example, a notary key based on a hardware-based cryptographic key is generated. In various embodiments, the notary key can be attested to by one or more hardware-based cryptographic keys such as a CPU-based and/or GPU-based cryptographic keys. In some embodiments, the notary key generation process includes securely storing at least the generated private key component of the notary key in a secure store within a trusted execution environment of the trusted computing environment. The notary key generation process further includes generating one or more attestation reports issued by one or more hardware-based cryptographic keys. An issued attestation report can include both the notary key and a representation of the operating environment such as a hash of the corresponding virtual machine file system. In some embodiments, container notary keys are also generated for each container supported by the trusted computing environment. The container notary keys can be signed by the generated notary key, and each generated container notary key can be specific to a particular container instance. In various embodiments, the generated attestation reports attesting to the generated notary key can be published, allowing them to be used to verify confidential compute operations. Moreover, the generated attestation reports can correspond to various proofs including non-interactive persistent proofs. For example, the generated proofs can remain valid and verifiable indefinitely and can be verified independently by a verifier without interaction with the prover.

At 405, computational operations are performed. For example, compute including confidential (or non-confidential) compute can be performed using the trusted computing environment configured at 401. In some embodiments, the computational operations performed correspond to executing program code on specified and/or provided inputs to generate corresponding outputs. In various embodiments, the computational operations are performed securely and confidentially utilizing one or more encrypted and/or isolated areas of memory that is protected from unauthorized access or modification. In some embodiments, GPU operations are supported by creating a secure session and/or channel between one or more CPUs and one or more GPUs. In some embodiments, in order to verify the performed computational operations, the program code is instrumented to trace the provided inputs and generated outputs. For example, declarations can be inserted into the program code to enable verifiable computing. As another example, functions or procedures can be called from the program code to enable verifiable computing. In some embodiments, verifiable computing is enabled by configuring the virtual machine used for execution of the program code. Other approaches are appropriate as well, including compiler-based and runtime enabled approaches that enabled verifiable computing based on compiler or runtime options, etc.

At 407, a computation statement is signed based on the notary key. For example, a computation statement corresponding to compute operations performed on input to generate output is created. The computation statement can include integrity-verifiable information for the inputs and outputs, where the executed program code can be included as one of the inputs. In some embodiments, hash values of the inputs and outputs are used to store the integrity-verifiable information for the inputs and outputs, and can include hashing the provided and generated data and programs for execution. In various embodiments, the notary key is used to sign the created computation statement. For computational operations performed within a container, a corresponding container notary key can be used to sign the computation statement.

At 409, the signed statement is exported. For example, the computation statement generated and signed at 407 is exported. In some embodiments, the signed statement is registered to a public blockchain with a time stamp. By publishing and/or sharing the signed statement, the confidential computational operations described by the signed statement can be publicly verified. Alternatively, the signed statement can be kept private and confidential without being shared or publicly disclosed. Once exported, both private and public signed statements can be verified. For example, using the attestations reports generated as part of the notary key generation process performed at 403, the signed statement exported at 409 can be authenticated by verifying the underlying signatures and the corresponding secure chain of trust. In some embodiments, the signed statement corresponds to one or more proofs, such as a proof of confidentiality, a proof of environment, a proof of correctness, a proof of computation, and/or a proof of governance, among others. Moreover, the signed statement can correspond to one or more non-interactive persistent proofs. For example, a corresponding proof of a signed statement can remain valid and verifiable indefinitely and can be verified independently by a verifier without interaction with the prover. In some embodiments, the proofs include proofs of inclusion and/or exclusion.

In some embodiments, the signed statement is exported outside the trusted computing environment by storing the signed statement in a verifiable compute manifest external to the trusted environment. For example, a public (or private) repository, database, or website can be used to store a manifest of the computations performed confidentially. As another example, the signed statement can be emailed to users and/or provided as a receipt for performed confidential compute. In some embodiments, the signed statement is processed automatically, such as by an automated program. In various embodiments, the signed statement and/or corresponding manifest is stored to a blockchain such as a public blockchain. The signed statement can further include one or more time stamps for verifiable computations, allowing different signed statements and their computations to be ordered according to their times of execution. For example, different signed statements and their computations can be ordered and chained together based on their timestamps, matching the output of one computation to the input of the computation that immediately follows it.

Although in some scenarios the signed statement is exported using a public medium, in various embodiments, the signed statement and corresponding manifests can be exported privately. For example, a signed statement can be exported and stored securely without revealing its contents and/or existence until needed. In various embodiments, at least in part due to the persistent and non-interactive proving properties of the signed statement, a signed statement can be optionally revealed at a later date for verification and proving purposes. For example, possession of a signed statement can be used to prove various proofs including proofs used to verify performed compute including confidential and/or non-confidential compute. The proofs can also be used to verify the computation environment and the data used or not used in the compute session. Other proofs are generated as well, as disclosed herein. Moreover, a signed statement may utilize hashed identifiers, providing additional security over the input, program code, and corresponding output described by the signed statement.

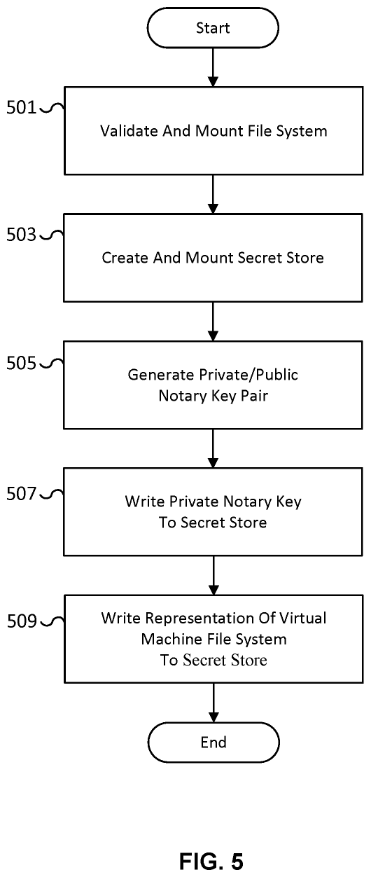

FIG. 5 is a flow chart illustrating an embodiment of a process for generating a notary key for a trusted computing environment. Using the process of FIG. 5, a notary key that is tied to the underlying hardware of the trusted computing environment and a hardware-based cryptographic key is generated. In various embodiments, the generated notary key can be used to attest to computing performed within a particular trusted computing environment. In some embodiments, the generated notary key is for a container used by a confidential virtual machine, and the generated container notary key is signed by a generated root notary key. In some embodiments, the process of FIG. 5 is performed at 403 of FIG. 4 by a trusted computing environment with a digital notary such as an instance of trusted computing environment with digital notary instances 131 of FIG. 1.

At 501, the file system is validated and mounted. For example, the file system of a confidential virtual machine is validated and mounted. In some embodiments, the virtual machine file system is validated by calculating a hash of the file system and comparing the computed hash to the expected hash. For example, a hash of the file system at the time of boot can be inserted into the kernel parameters, which are incorporated into the memory that is part of launch measurements. In some embodiments, this allows the memory to be measured by the trusted execution environment and can result in a fault or system halt in the event the file system hash does not match its expected value. In the event the file system is validated, the file system is then mounted. In some embodiments, attestation using a trusted hardware-based cryptographic key is performed to verify the integrity of the virtual machine and that it is running on trusted hardware.

At 503, the secret store is created and mounted. For example, a secure secret store is created and mounted using hardware-based cryptographic keys. In some embodiments, the secret store can correspond to an encrypted RAM disk that is mounted on the virtual machine file system. The secret store can be encrypted with a hardware key of the trusted execution environment.

At 505, a private/public notary key pair is generated. For example, a private notary key can be generated from a random number sequence (such as a random 32-bit or another bit-length number sequence) within the trusted computing environment, and using the private key, a corresponding public key can be derived. In some embodiments, the generated notary key is a private-public key pair such as an asymmetric elliptic-curve key pair. In some embodiments, the private/public notary key pair can be created using a hardware cryptographic module. Where appropriate, different cryptographic standards including known, open, and/or published standards for key generation, encoding, decoding, encryption, description, presentation, formatting, registration, publication, sharing, etc. can be used. For example, distinguished encoding rules (DER) can be used to encode elliptic curve (EC) cryptographic data including to serialize and exchange keys, signatures, and certificates.

In some embodiments, communication with an external party can utilize the generated notary key. For example, an SSL certification can be optionally created using the generated notary key. This allows an external party to authenticate its connection to the trusted computing environment by retrieving a shared attestation report and comparing the report to the SSL certificate. Using the provided SSL certificate ensures that the external party is communicating securely to the intended system and confidential environment.

In some embodiments, the generated notary key is used for providing persistent proofs of communication with third parties. For example, a verifiable gateway can help maintain and/or ensure the integrity of a workflow that relies on third-party services including API services. Using the notary key and related notary system, the trusted computing environment can function as a trusted witness to network traffic, including TLS traffic, between itself and a third-party server. Certificates of third-party servers can be validated and a confidential guarantee that the trusted computing environment and associated trusted execution environment is secure and authentic is provided. These generated persistent proofs, which can be independently and retroactively verified, can attest that a connection is valid including that session keys for the connection have not been leaked. In some embodiments, applications of these proofs are used to confirm that a connection was not spoofed at the time of communication.

At 507, the private notary key is written to the secret store. For example, the private notary key generated at 505 is written to the secret store created at 503. In some embodiments, once the private notary key is written to the secret store, the private notary key remains stored in the secret store and can be unreadable outside of the secret store. In some embodiments, a hardware cryptographic module supports the creation and writing of the notary key within a secret store.

At 509, a representation of the virtual machine file system is written to the secret store. For example, a representation of the virtual machine file system such as a hash of the virtual machine file system is generated and stored in the secret store. In some embodiments, the generated public notary key is stored along with the hashed representation of the virtual machine file system. When combined, the virtual machine file system hash and notary key information can be used to generate an attestation report, which can be signed by a hardware cryptographic key of the corresponding trusted computing environment. The hardware key can be a CPU-based cryptographic key and additionally a GPU-based cryptographic key, if appropriate. Moreover, a generated attestation report can be exported and/or registered, such as on a blockchain and/or with a private database, allowing statements signed by the notary key to be independently verified. In various embodiments, the generated attestation report corresponds to one or more non-interactive persistent proofs. For example, a published attestation report can remain valid and verifiable indefinitely and can be verified independently by a verifier without interaction with the prover or trusted computing environment. In some embodiments, the current state of the virtual machine file system corresponds to the state of a confidential virtual machine file system with a digital notary that can be used for performing computing (including confidential computing) where the performed computing can be verified.

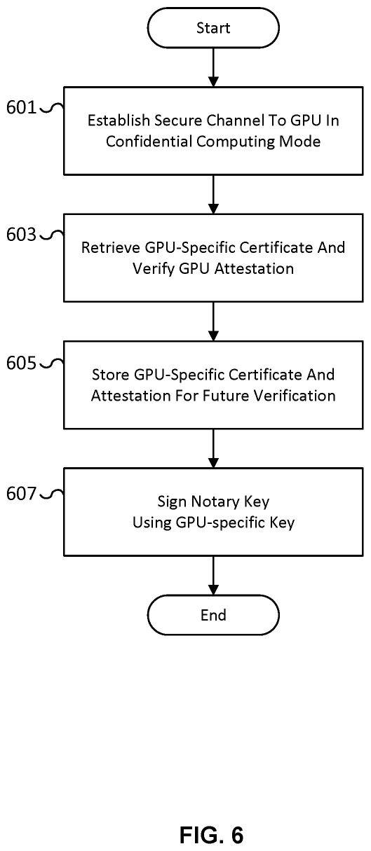

FIG. 6 is a flow chart illustrating an embodiment of a process for generating a notary key for a trusted computing environment that includes a GPU. Using the process of FIG. 6, a notary key can be further tied to the underlying GPU hardware of the trusted computing environment by utilizing the GPU-based cryptographic key. In various embodiments, the generated notary key can be used to attest to computing performed on specific GPU hardware within a particular trusted computing environment. In some embodiments, the generated notary key is for a container used by a confidential virtual machine enabled with a GPU, and the generated container notary key is signed by a generated root notary key. In some embodiments, the process of FIG. 6 is performed at 403 of FIG. 4 and/or at 505 of FIG. 5 by a trusted computing environment with a digital notary such as an instance of trusted computing environment with digital notary instances 131 of FIG. 1.

In some embodiments, the results of the process of FIG. 6 create at least two additional persistent proofs related to the GPU confidential compute mode. A proof of environment from the GPU and a proof of confidentiality from the GPU are both created. For example, a proof of environment from the GPU can correspond to a persistent proof of the genuine origin of the GPU, the type of GPU, the features enabled in the trusted computing environment, which firmware was enabled, and corresponding measurements of the hardware and firmware. The proof of environment allows auditors to prove the integrity of the genuine GPU hardware and environment. A proof of confidentiality from the GPU can correspond to a persistent proof that the confidential computing mode has been enabled on the GPU. This can be used to ensure that the GPU VRAM is encrypted and only accessible to the current confidential virtual machine. The proof of confidentiality allows auditors to prove that the system did not leak information, such as to a guest user or virtual machines, and remained secure throughout the requested compute processing. In various embodiments, the proofs are non-interactive persistent proofs. For example, the generated proofs can remain valid and verifiable indefinitely and can be verified independently by a verifier without interaction with the prover.

At 601, a secure channel to a GPU in confidential computing mode is established. For example, a GPU is placed into confidential computing mode and a secure channel to the GPU is established. In various embodiments, the secure channel is established between a trusted execution environment of the CPU and the trusted execution environment of the GPU, triggering encryption of associated memory and loading of the GPU drivers.

At 603, a GPU-specific certificate is retrieved, and GPU attestation is verified. For example, the GPU can generate an attestation of the firmware and drivers that are loaded on the GPU. In some embodiments, the GPU attestation is verified including by retrieving a certificate for the specific GPU and checking its validity. The GPU-specific certificate is used to verify the status of the certificate and the authenticity of the generated GPU attestation. Once verified, the GPU can be enabled for use including to offload computation to the GPU hardware. In some embodiments, the verification applies to the GPU hardware, firmware, configuration, and drivers. This proof of the secure environment, however, has not yet been exposed to end users and cannot be audited.

At 605, the GPU-specific certificate and attestation is stored for future verification. For example, the retrieved GPU-specific certificate and generated attestation can be stored for later reference.

At 607, the notary key is signed using the GPU-specific key. For example, the notary key is inserted into an attestation report that is signed by the GPU cryptographic key. The GPU attestation verifies the link between the GPU and the CPU environment for a specific trusted computing environment. The notary key now has proof of the integrity of the CPU and GPU compute environment and data confidentiality. The key can be deployed to sign all system inputs and outputs. The system input payloads can include data and models for training and models for evaluation. The system output can include results generated from a training data set or evaluations, logs, constructed database, and/or other generated artifacts.

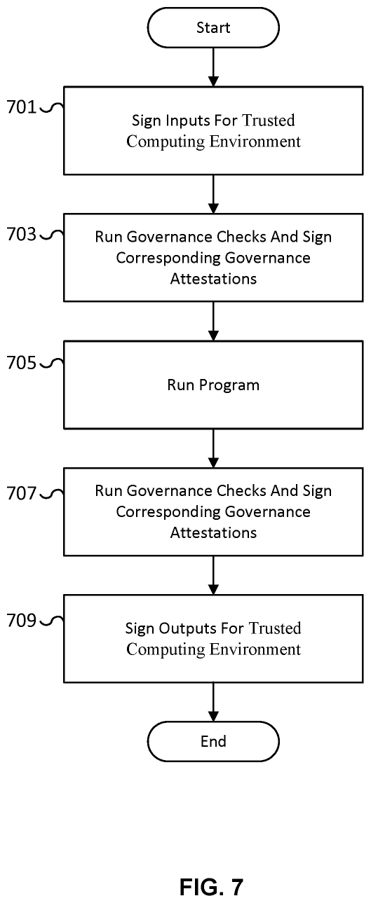

FIG. 7 is a flow chart illustrating an embodiment of a process for supporting verifiable computing using a digital notary. Using the process of FIG. 7, a hardware-based notary key can be used to support authenticated compute by attesting to performed computing sessions and operations. The signed attestation statements can be verified allowing others including independent parties to verify the performed computing including compliance with governance checks. In various embodiments, the notary key is tied to the trusted computing environment and utilizes hardware-based cryptography to achieve the necessary performance and efficiency. In addition to authenticated compute, during program execution, pre-programmed governance checks can be run to verify that certain parameters are met. Corresponding governance attestations signed by the notary key are produced for each execution of these governance checks. In various embodiments, with the generated governance attestations, verifiers can confirm that implemented governance controls have passed (or failed) at runtime, that the computation was policy-compliant, and/or that the data quality of produced artifacts are assured. In some embodiments, the process of FIG. 7 is performed at 405 and/or 407 of FIG. 4 by a trusted computing environment with a digital notary such as an instance of trusted computing environment with digital notary instances 131 of FIG. 1. In some embodiments, the governance checks that are run correspond to governance 223 of FIG. 2.

In some embodiments, the results of the process of FIG. 7 create at least three additional cryptographic proofs. In addition to proofs of environment and confidentiality, a proof of correctness, a proof of computation, and a proof of governance are created. In some embodiments, the process of FIG. 7 provides a proof of environment from the CPU and/or GPU. Proof of environment from the CPU can correspond to a persistent proof of the genuine origin of the CPU from its manufacturer or vendor (such as from Intel, AMD, or another origin source), the type of CPU, the features enabled in the environment, and/or which security firmware was enabled. In various embodiments, the CPU may not directly attest to measurements of the open virtual machine firmware (OVMF), kernel, and/or initial RAM disk by default, however, the CPU's participation in integrity measurement architectures allows for secure software attestation of these components. This proof allows auditors to prove the integrity of the genuine CPU hardware and environment. With respect to a GPU, proof of environment from the GPU can correspond to a persistent proof of the genuine origin of the GPU (such as from NVIDIA or another origin source), the type of GPU, the features enabled in the environment, which firmware was enabled, and/or corresponding measurements including hardware and/or firmware measurements. This proof allows auditors to prove the integrity of the genuine GPU hardware and environment.

In some embodiments, the process of FIG. 7 provides a proof of confidentiality from the CPU and/or GPU. Proof of confidentiality from the CPU can correspond to a persistent proof that the file system has not been modified after boot by the CPU. This proof allows auditors to prove that the system did not leak information and remained secure throughout processing. With respect to a GPU, proof of confidentiality from the GPU can correspond to a persistent proof that confidential computing mode has been enabled on the GPU, which ensures that the VRAM is encrypted and only accessible to the current virtual machine. This proof allows auditors to prove that the system did not leak information to the guest or other virtual machines and remained secure throughout the processing.

In various embodiments, the process of FIG. 7 further provides proof of correctness. For example, since the notary key for the trusted computing environment is attested to by the underlying hardware, such as the trusted execution environments of utilized CPUs and GPUs, a proof of correctness provides proof that the intended program was run on genuine CPU and GPU hardware. This provides a new persistent proof that computation on a specific input yielded a specific output. The proof of correctness addresses several attack vectors by giving administrators the assurance that only the intended code was run and no malicious software has manipulated the outputs. Moreover, the proof fills an important gap in the chain of integrity of execution of code. Traditional confidential computing prevents a host from tampering with the execution—but does not prevent the system administrator of the guest virtual machine, or anyone with remote access to the virtual machine after boot, from tampering with the code. In other words, the intended output would no longer be correct and the manipulation of the process would be undetectable to an independent third party. With the generated persistent proof of correctness, auditors can also retroactively inspect the file system and containers to ensure only the intended code was executed and no malicious software was present at the time of execution. In various embodiments, the proofs are non-interactive persistent proofs. For example, the generated proofs can remain valid and verifiable indefinitely and can be verified independently by a verifier without interaction with the prover.

In various embodiments, the process of FIG. 7 provides proof of computation. For example, since the notary key has proof of the integrity of the CPU and GPU computing environment and the CPU and GPU, it can be deployed to sign all the metrics of a specific computation session. These metrics include, for example, power usage of the GPU, any throttling of the GPU, utilization of the GPU, CPU, and other resources such as RAM, VRAM, and network activity during the session, among other metrics. With a persistent proof of computation, auditors can now retroactively prove that the expected computation resources were expended, such as to fulfill an AI computational task. This ensures that compute providers and publishers can accurately represent that the compute process was not interrupted by a lack of resources and can be held accountable for any claims they have about the performance of the model creation or inference.

In various embodiments, the process of FIG. 7 also provides proof of governance. With the assurance of correct program execution in a specific trusted computing environment, binding governance controls can be implemented during program execution and produce persistent proof that the checks have passed or failed at runtime. These governance controls may include verification of remote assets, quality check of runtime artifacts, or other controls for fulfilling compliance requirements or business policies. In the event these controls are not met, application logic may halt or continue execution. In either event, signed governance attestations are produced that can be verified against the notary key, such that future claims of compliance are backed by cryptographic evidence.

At 701, the inputs for the trusted computing environment are signed. For example, inputs for the trusted computing environment are signed using the hardware-based notary key. In some embodiments, the inputs are first hashed, and only the hashed versions of the inputs are signed and registered. By utilizing hashed versions of the inputs, the input data can remain hidden and secure and only revealed if necessary, such as to confirm knowledge or ownership of the original input data.

At 703, governance checks are run and corresponding governance attestations are signed. For example, the runtime environment and/or program run at 705 can be augmented to run governance checks within the trusted computing environment. In some embodiments, the governance checks correspond to compute operations used to confirm that certain controls or policies are met ahead of running the specific program at 705. The performance of computational operations used to implement the governance checks results in generated governance attestations. To allow the attestations to be verified, the governance attestations are signed with a notary key of the trusted computing environment. A signed governance attestation can include representations of all input and output associated with the governance such as all input and output files, parameters, and/or program code. A governance attestation can also include a description or representation of a trusted computing environment. In various embodiments, a signed governance attestation corresponds to a proof of governance that can be independently verified and audited.

At 705, a program is run within the trusted computing environment. For example, the desired program code, which may be specified and/or included as an input to the trusted computing environment, is executed within the trusted computing environment. In some embodiments, the program code is executed confidentially, such as by using a hardware supported confidential computing mode. For example, a trusted execution environment can be used for performing confidential computing using the program including by using one or more encrypted and/or isolated areas of memory that are protected from unauthorized access or modification. In some embodiments, the program is run in a non-confidential computing mode.

At 707, governance checks are run, and corresponding governance attestations are signed. For example, similar to the governance step performed at 703, the runtime environment and/or program run at 705 can be augmented to run governance checks within the trusted computing environment. In some embodiments, the governance checks correspond to compute operations used to confirm that certain controls or policies are met after running the specific program at 705. The performance of computational operations used to implement the governance checks results in generated governance attestations. To allow the attestations to be verified, the governance attestations are signed with a notary key of the trusted computing environment. A signed governance attestation can include representations of all input and output associated with the governance such as all input and output files, parameters, and/or program code. A governance attestation can also include a description or representation of a trusted computing environment. In various embodiments, a signed governance attestation corresponds to a proof of governance that can be verified and audited.

At 709, the outputs for the trusted computing environment are signed. For example, outputs for the trusted computing environment generated by running the program at 705 are signed using the hardware-based notary key. In some embodiments, the outputs are first hashed and only the hashed versions of the outputs are signed and registered. By utilizing hashed versions of the outputs, the output data can remain hidden and secure and only revealed if necessary, such as to confirm knowledge or ownership of the original output data.

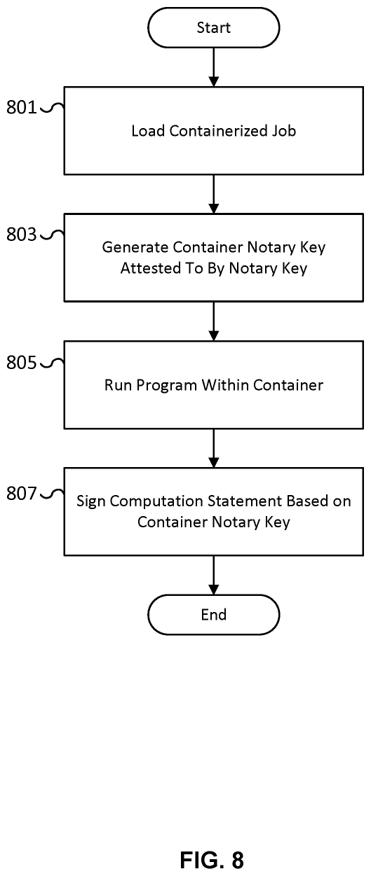

FIG. 8 is a flow chart illustrating an embodiment of a process for supporting verifiable computing performed in a container. Using the process of FIG. 8, a container system is integrated with the trusted computing environment to allow for additional efficiency and flexibility for performing verifiable computing. In some scenarios, auditing and trusting the root file system of a confidential virtual machine can present challenges, and a container approach is implemented at least in part to ensure confidence in the integrity of the notary key. For example, using a container approach can significantly minimize the audit frequency of each new root file system for each workload. With a container approach, a limited set of API function calls can be provided to manage workloads, and one root file system can host different externally-loaded workloads after the confidential virtual machine has booted. Moreover, instead of utilizing only a single notary key, each container can utilize its own asymmetric container notary key that is signed using a root notary key. In some embodiments, the process of FIG. 8 is performed at 405 and/or 407 of FIG. 4 by a trusted computing environment with a digital notary that supports containers such as an instance of trusted computing environment with digital notary instances 131 of FIG. 1. In some embodiments, the confidential virtual machine used by the trusted computing environment is confidential virtual machine with notary key 301 of FIG. 3.

At 801, a containerized job is loaded. For example, the appropriate container image for the job can be identified, retrieved, and loaded. The specific container can be configured with the appropriate resources needed to complete the intended computing job. In some embodiments, the container is an isolated environment for running the intended program job and includes the necessary code, runtime, libraries, state, and other tools for computing (including confidential computing) while also being lightweight in size and more resource efficient than utilizing an entire virtual machine.

At 803, a container notary key is generated and attested to by the notary key. For example, a container notary key is generated and stored in a secure secret store of the trusted execution environment. In various embodiments, the container notary key is signed by the notary key, and each container session generates its own asymmetric container notary key scoped to the specific containerized workload. This allows each container to maintain a clear separation and prevents unrelated jobs from producing proof artifacts signed by the same notary key. Since the container notary key is signed by a hardware-based notary key, the container notary key is similarly tied back to the hardware-based cryptographic key of the trusted computing environment.

In some embodiments, the container notary key and a representation of the container is attested to by the notary key, creating a secure chain of trust back to the hardware-based cryptographic key. The representation of the container can be a hash of the container and relevant metadata. In some embodiments, the root file system includes an endpoint, accessible only to containers, that facilitates content signing with the container's notary key. This enables containers to participate in the signing process without direct access to the private key, enhancing security and integrity.

In various embodiments, neither the private key of the system notary nor container notary is directly readable from the loaded container. This security feature greatly reduces the risk of a key leak, and the amount of code that needs to be hardened and audited. As long as the confidential virtual machine layer above the container is secured against direct access to the notary private keys, arbitrary code running in the containers cannot read or export any of the private keys. Additionally, utilization is limited to local access where the containerized code may request a signature from its designated container notary private key, and the signature proof, not the private signing key itself, is returned to the container code to handle.

At 805, a program is run within a container. For example, similar to step 705 of FIG. 7, the desired program code, which may be specified and/or included as an input to the trusted computing environment, is executed within the trusted computing environment. Unlike the step 705 of FIG. 7, the program is run within the container loaded at 801 and relies additionally on the generated container notary key. In various embodiments, a trusted execution environment is used for performing computing (including confidential computing, if appropriate) using the loaded container and desired program. The performed compute may use one or more encrypted and/or isolated areas of memory that are protected from unauthorized access or modification. In some embodiments, the container is first validated before the desired program is run, for example, by verifying a hash of the container that has been attested to by the container notary key.

At 807, a computation statement is signed based on a container notary key. For example, a computation statement with inputs and outputs corresponding to the program run at 805 is signed using the container notary key generated at 803. In some embodiments, the inputs and outputs are first hashed, and only the hashed versions of the input and outputs are signed and registered. By utilizing hashed versions of the inputs and outputs, the original data can remain hidden and secure and only revealed if necessary, such as to confirm knowledge or ownership of the original data. In some embodiments, the program run at 805 is treated as an input for the signed computation statement.

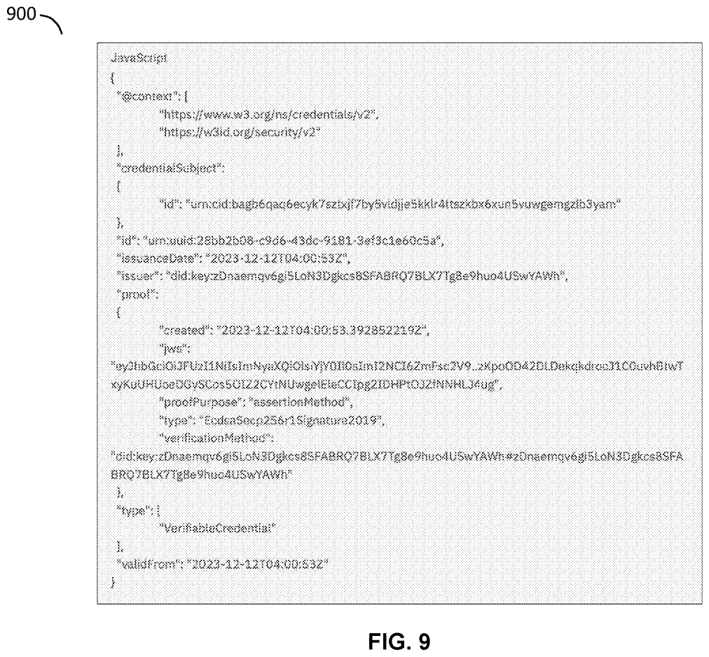

FIG. 9 is a diagram of an embodiment of an issued verifiable credential. In the example shown, issued verifiable credential 900 corresponds to an issued credential from a trusted computing environment. In some embodiments, the trusted computing environment is an instance of trusted computing environment with digital notary instances 131 of FIG. 1 and/or trusted computing environment with digital notary 200 of FIG. 2. Issued verifiable credential 900 is issued with a notary key associated with the trusted computing environment and linked to a hardware-based trusted execution environment. In various embodiments, issued verifiable credential 900 has a chain of trust that ties it to a hardware-based cryptographic key. In the example shown, the notary key is a secp256r1 notary key and represented in issued verifiable credential 900 as: did:key:zDnaemqv6gi5LoN3Dgkcs8SFABRQ7BLX7Tg8e9huo4USwYAWh. The notary key can be used to sign a proof section of a document including for computation statements. Additionally, issued verifiable credential 900 and the included the notary key can be verified and authenticated using the details included in issued verifiable credential 900.

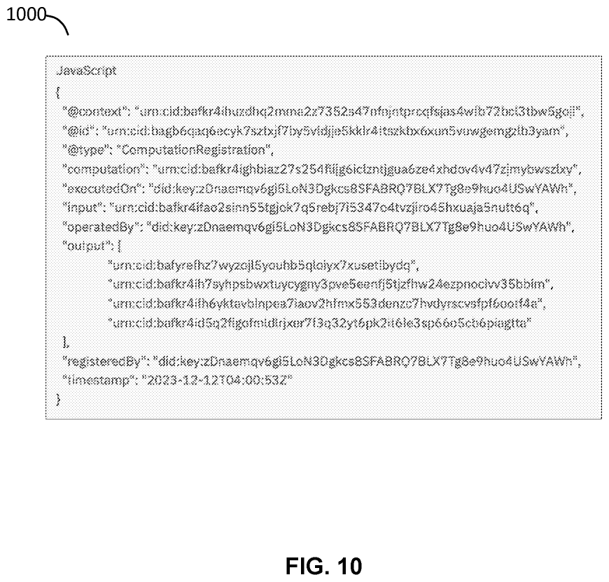

FIG. 10 is a diagram of an embodiment of a signed computation statement. In the example shown, signed computation statement 1000 corresponds to an authenticated computation performed by a trusted computing environment that can verified. In some embodiments, the trusted computing environment is an instance of trusted computing environment with digital notary instances 131 of FIG. 1 and/or trusted computing environment with digital notary 200 of FIG. 2. Signed computation statement 1000 includes a hash-based identifier for the computation and can be authenticated using the credentials of issued verifiable credential 900 of FIG. 9. In issued verifiable credential 900, the hash-based identifier is: urn:cid:bagb6qaq6ecyk7sztxjf7by5vldjje5kklr4ttszkbx6xun5vuwgemgzlb3yam. Moreover, issued verifiable credential 900 includes hashed representations of the input and output associated with the computation along with a timestamp of the computation, among other additional fields such as @context, @id, @type, executedOn, operatedBy, and registeredBy.

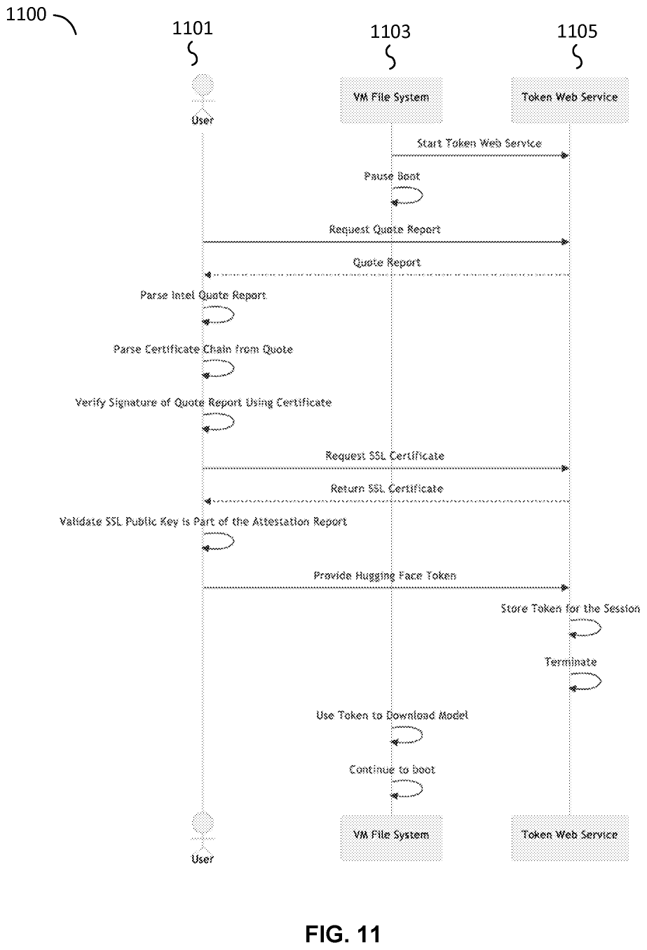

FIG. 11 is a flow diagram illustrating an embodiment of a process for implementing a confidential AI model. As shown in FIG. 11, the process 1100 includes client user 1101, virtual machine system 1103, and token web service 1105. The process shown in FIG. 11 is an example use case that utilizes the verifiable compute techniques and systems disclosed herein to allow users to interactively provide a token to download a private AI model from an AI model repository. In some embodiments, client user 1101 is client 101 of FIG. 1. In some embodiments, virtual machine system 1103 is confidential virtual machine with notary key 213 of FIG. 2 and/or confidential virtual machine with notary key 301 of FIG. 3. In some embodiments, token web service 1105 corresponds to an instance of trusted computing environment with digital notary instances 131 of FIG. 1 and/or trusted computing environment with digital notary 200 of FIG. 2. In some embodiments, virtual machine system 1103 and token web service 1105 may correspond to the same trusted computing environment.

Starting from the top of FIG. 11 and moving downwards with the flow of time, virtual machine system 1103 initiates the start of token web service 1105 before pausing its boot process. Client user 1101 then requests a quote report, parses the report and corresponding certificate chain, and then verifies the signature of the quote report using the parsed certificate. In various embodiments, the quote report is an attestation report based on a notary key and a hardware-based cryptographic key. Client user 1101 then requests and receives an SSL certificate from token web service 1105 and then validates that the SSL public key is part of the attestation report. In some embodiments, the SSL certificate can be generated using a notary key associated with a trusted computing environment. Client user 1101 provides the model token (shown as a token provided by the Hugging Face AI model repository) to token web service 1105. Token web service 1105 stores the token for the session and then terminates. Virtual machine system 1103 uses the token to download the confidential AI model and then continues the boot process.

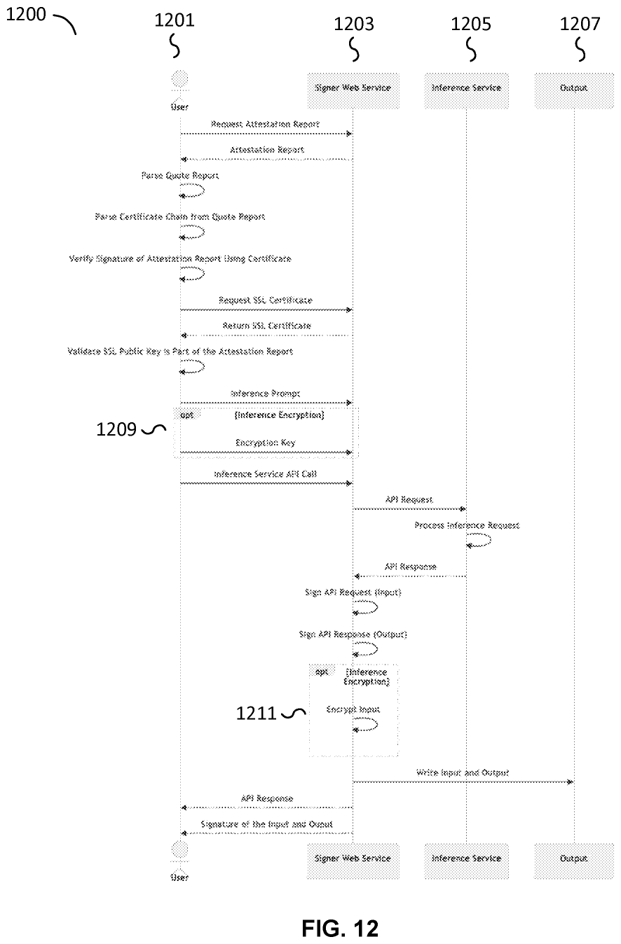

FIG. 12 is a flow diagram illustrating an embodiment of a process for performing verifiable and confidential inference. As shown in FIG. 12, the process 1200 includes client user 1201, signer web service 1203, inference service 1205, and output 1207. The process shown in FIG. 12 is an example use case that utilizes the verifiable compute techniques and systems disclosed herein to perform verifiable inference including verifiable confidential inference. Optional steps related to the ability to enable confidential inference correspond to optional inference encryption steps 1209 and 1211. In some embodiments, client user 1201 is client 101 of FIG. 1. In some embodiments, signer web service 1203 corresponds to an instance of trusted computing environment with digital notary instances 131 of FIG. 1 and/or trusted computing environment with digital notary 200 of FIG. 2. In some embodiments, inference service 1205 can also be a trusted computing environment for performing verifiable computing such as an instance of trusted computing environment with digital notary instances 131 of FIG. 1 and/or trusted computing environment with digital notary 200 of FIG. 2. In some embodiments, signer web service 1203 and inference service 1205 may correspond to the same trusted computing environment.

Starting from the top of FIG. 12 and moving downwards with the flow of time, client user 1201 initiates the process by requesting an attestation report from signer web service 1203 and then parses the corresponding certificate chain and verifies the signature of the attestation report. Client user 1201 requests and receives an SSL certificate and validates that the SLL public key is part of the received attestation report. Client user 1201 then provides an inference prompt to signer web service 1203 and optionally an encryption key at optional inference encryption step 1209. In response to the inference prompt and inference service API call by client user 1201, signer web service 1203 initiates an API request to inference service 1205 to process the inference request. The initial API request initiated by client user 1201 and the API response from inference service 1205 are both signed by signer web service 1203. In some embodiments, the API request corresponds to input and the API response corresponds to output of a computation statement that can be performed confidentially. In the event encryption is enabled, the input is encrypted at optional inference encryption step 1211. Both the input and the output are then written to output 1207. In the event encryption is enabled, an encrypted version of the input is written to output 1207 to maintain confidentiality. The API response is returned from signer web service 1203 to client user 1201 along with a signature of the input and output. In various embodiments, the signed input and output can be verified using an initial attestation report. When performed confidentially, the signed computation statement corresponding to the signed input and output can be used to independently verify the confidential inference compute performed.

### Additional Description of Various Embodiments of Infrastructure and Processes

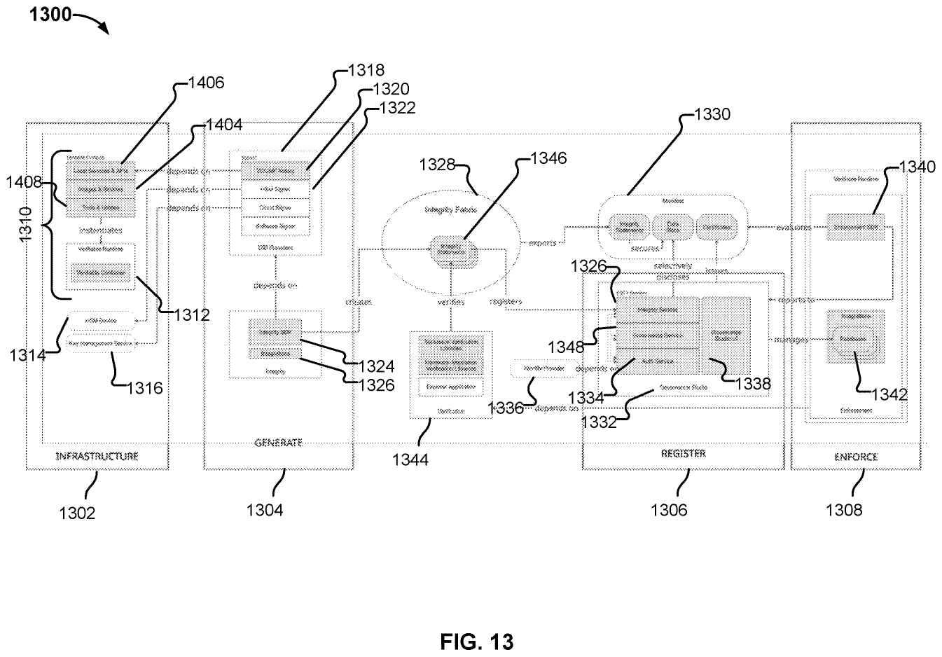

FIG. 13 illustrates an example of an embodiment of an environment providing verification. Various elements illustrated in FIG. 13 are examples of elements illustrated in FIGS. 1-3, as applicable. In an example implementation, portions 1302, 1304, 1306, and 1308 are hosted on (or otherwise provided/managed by) customer infrastructure, which can include bare metal, cloud-based infrastructure, etc., or combinations thereof. Various elements depicted in FIG. 13 can be instantiated, e.g., in an Azure confidential compute environment, and then interacted with via various tools described herein. As an example, a customer can use a Hardware Security Module in conjunction with the customer's Azure account, and can also use other equivalent (e.g., self-hosted) infrastructure in accordance with various embodiments described herein.

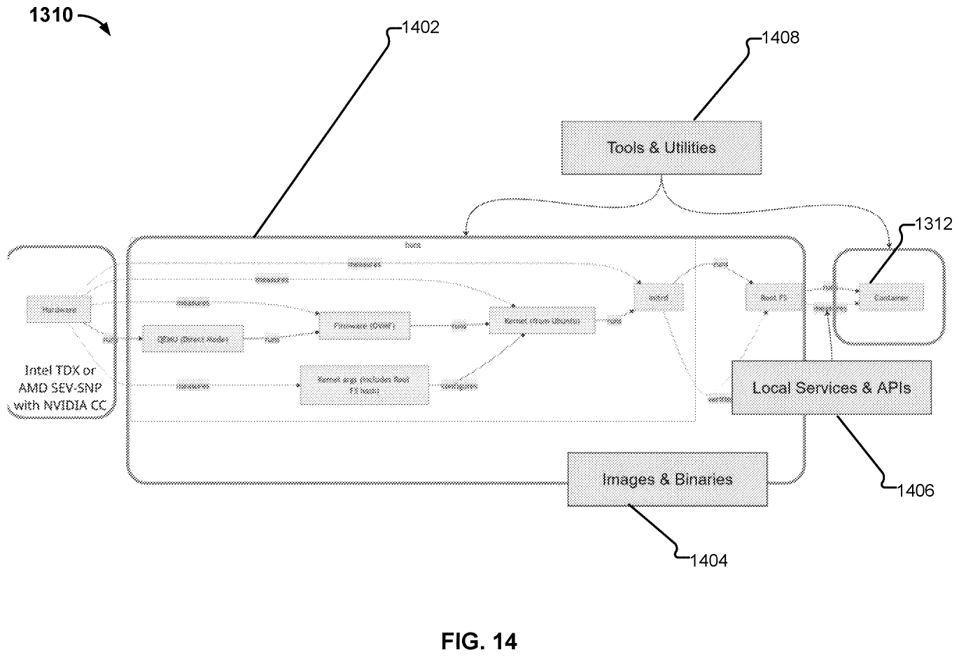

One goal that can be accomplished using various techniques described herein is to verify a job running in verifiable container 1312. FIG. 14 illustrates various elements of verifiable compute stack 1310. Examples of hardware (also described above) that can be used for verifiable compute stack 1310 include an Intel TDX or an AMD SEV-SNP machine with or without NVIDIA Confidential Computing capabilities, which can be present either as a part of a customer's on-premise bare metal infrastructure or provided by a cloud provider (on behalf of the customer), or combinations thereof, as applicable. Region 1402 of FIG. 14 illustrates an example of a boot process used by verifiable compute stack 1310. As described in more detail above, various aspects of the boot process comprise either open source software elements or custom images that have been made auditable (1404), such as the kernel image and the root system binary. Local services/APIs 1406 provide an interface for interactions between the root filesystem and container 1312. As mentioned above, the root filesystem notary is able to generate a signing key for the container, and infrastructure is provided to support trust guarantees that the correct container is being run and signatures are tied to the correct container. Finally, tools and utilities (1408) are usable to spin up a given environment and to orchestrate workloads that will run in the environment (e.g., command line utilities to instruct compute stack 1310 to run a payload). Other elements can also be optionally included as part of a customer's infrastructure (1302) as applicable, such as an HSM device 1314 or key management service 1316 (e.g., for Use Outside of Verifiable Compute Tasks).

Proof generation stack 1304 illustrates a variety of types of signers 1318 (also referred to as decentralized identity (DID) providers) that can be used to identify who is signing something. In particular, verifiable compute notary 1320 can be used in conjunction with verifiable compute stack 1310 and techniques described herein to provide signatures that can attest to hardware (and the applicable software used to generate artifacts). Other types of signers can also be used in the environment, e.g., with other infrastructure, such as using an HSM signer 1322 with HSM device 1314 based on security requirements. As an example, for lower security risk tasks (e.g., signing a single, mundane transaction), a customer implementing an embodiment of the environment shown in FIG. 13 could use HSM device 1314 and corresponding HSM signer 1322. For higher security risk tasks (e.g. performing a custom computation in a verifiable manner), a verifiable environment where arbitrary workloads are performed and signed, notary 1320 and verifiable compute stack 1310 can be used. Additional information about embodiments of verifiable compute notary 1320 is provided above.

In various embodiments, signer(s) 1318 is a software component used by an integrity SDK 1324. Integrity SDK 1324 is used by customer developers to integrate (e.g., as a dependency) verifiable compute techniques into the customer's applications/other resources. As applicable, integrations 1326 are provided so that customers using standard libraries can more easily make use of the integrity SDK without requiring the addition of undue instrumentation. The integrity SDK generates a set of proofs that can be collected as signed integrity statements 1346 (e.g., files). The global collection of all statements is also referred to herein as integrity fabric 1328. In various embodiments, the customer's integrity statements can be stored either on the customer's filesystem, or can be indexed using integrity service 1326 (which can also be run within the customer's premises (whether bare metal or cloud-based)). Integrity service 1326 comprises a set of databases with an API that allows statements to be added, indexed, searched, and retrieved for various purposes.

Statements can also be exported into packaging formats such as manifest 1330 (which can be implemented, e.g., as a JSON file). As applicable, data blobs can also be embedded in manifest 1330. As an example, if a data object such as an image is described in a statement, that image can be embedded into the manifest as well. The statement can be used to secure the blob, because if the blob is altered, the integrity statement that is signed will make it evident that someone has tempered with the blob.

In a typical customer environment, the integrity service (along with other services shown in governance studio 1306) is not necessarily run on verifiable compute, but on a commodity containerization platform such as Kubernetes. Integrity service 1326 provides a comprehensive platform for registering, linking, and verifying digital assets, identities, computations, and their associated cryptographic proofs, supporting strong guarantees of trust, auditability, and data integrity in distributed environments. It is the primary API service to store, query, and retrieve integrity statements. It features:
Native understanding of the integrity statement schema and integrity fabric.
CID, DID, and VC utilities and data canonicalization features.
Support for capturing integrity records and attestation documents from governance workflows.
Dynamic generation of integrity manifests based on query parameters.
Integration with a blob store for storing various integrity-relevant data, such as hashes associated with a collection or proof assets associated with a verifiable compute notary.

Governance service 1348 is a GRC-like interface. It allows users to make use of the integrity data and (as applicable) apply human governance and continuous monitoring to systems. It provides a flexible and extensible policy evaluation engine for compliance monitoring of resources against defined policies, along with comprehensive governance timeline management. It features:
Policy implementation and management with controls, declarations, and reviews.
Cryptographically-secured and tamper-evident record of the end-to-end governance workflow.
Timeline-based governance tracking with comprehensive reporting features.
Continuous monitoring through evaluation of events in real-time.
Support for complex compliance criteria through user-defined indicators.
Integration with major enterprise identity providers.
Integration with governance studio 1338.

An authentication service 1334 works with an identity provider 1336 to integrate into identity and access management services such as Keycloak, Auth0, and Microsoft Entra ID.

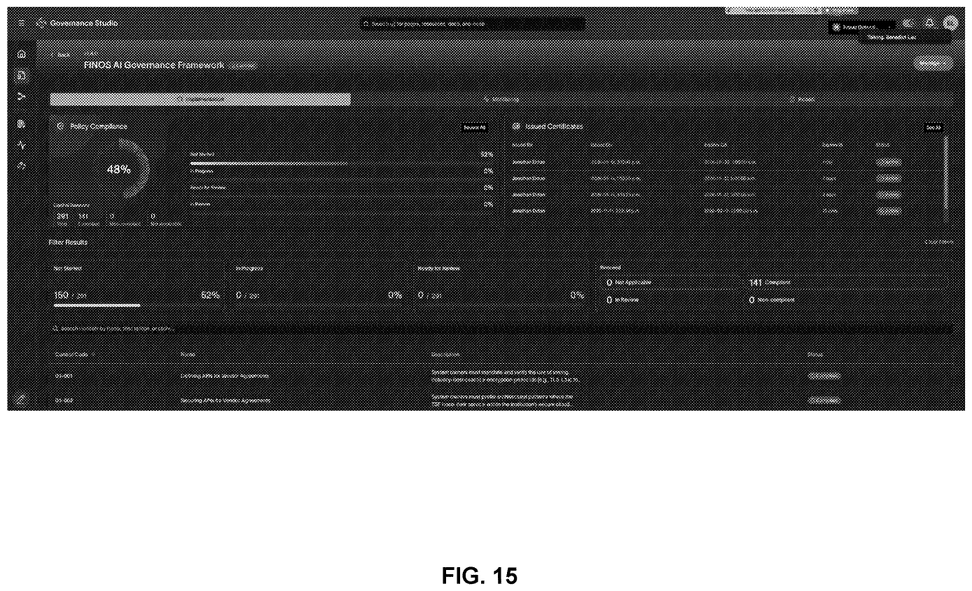

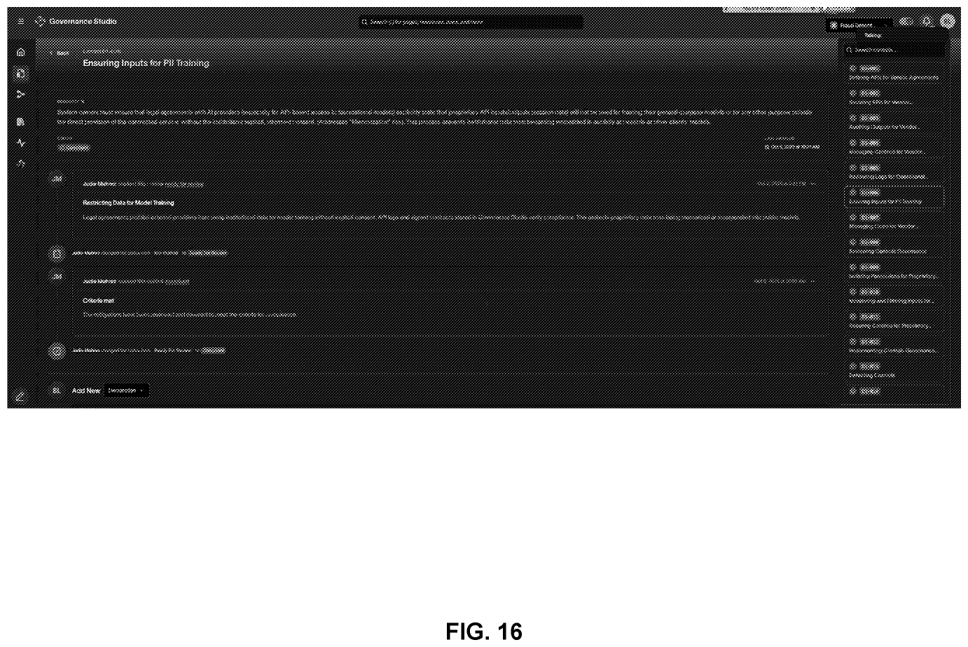

Examples of interfaces provided by governance studio user interface 1338 are shown in FIGS. 15-18. In particular, a governance framework as applied to a fraud detection project is illustrated, showing aspects of a process for carrying out compliance documentation and approval. Each framework is broken down into many controls (e.g., control D1-001 and D1-002 as shown in FIG. 15) which can be clicked on. As illustrated in FIG. 16, a user, Judie, has entered data into the system. She can make declarations, do reviews, and toggle the state of controls (e.g., based on role-based access permissions). Judie can also configure continuous monitoring, so that if something is wrong during the operation of the governed system (e.g., expected criteria is not met) an alert is generated. She can also get a report of the chronological process of each of the controls, as well as the overall policy as applied to the project. In various embodiments, the report comprises a list of signed attestations of the governance process (e.g., signed declarations). Each attestation has a statement associated with it. So, each time a human (e.g., Judie) produces an attestation, the system also generates a statement. These human-based attestations can also be included as part of the integrity fabric 1328 in addition to items signed via verifiable compute (and, as applicable, included in manifest 1330 by governance studio 1332 through integrity service 1326, etc.).

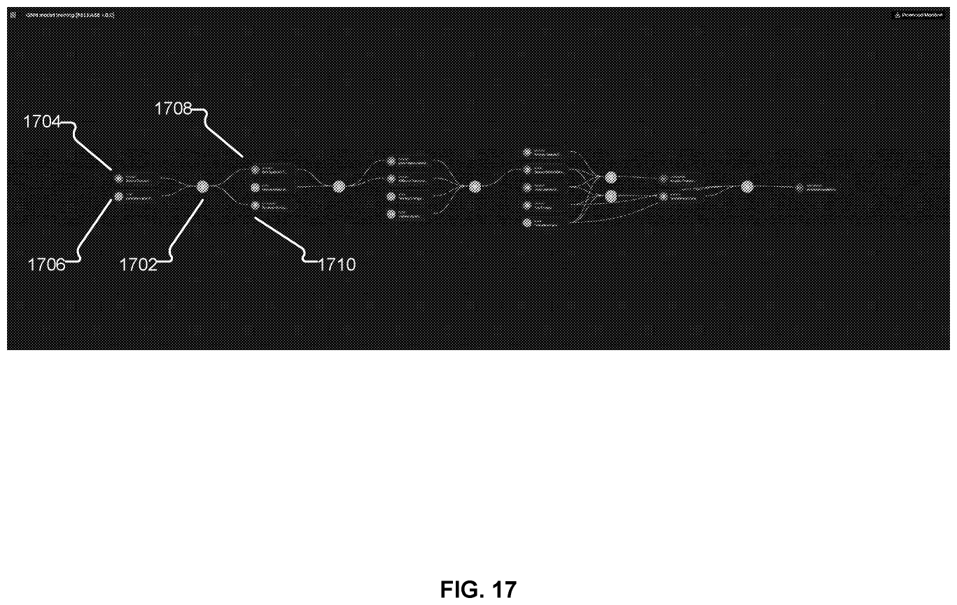

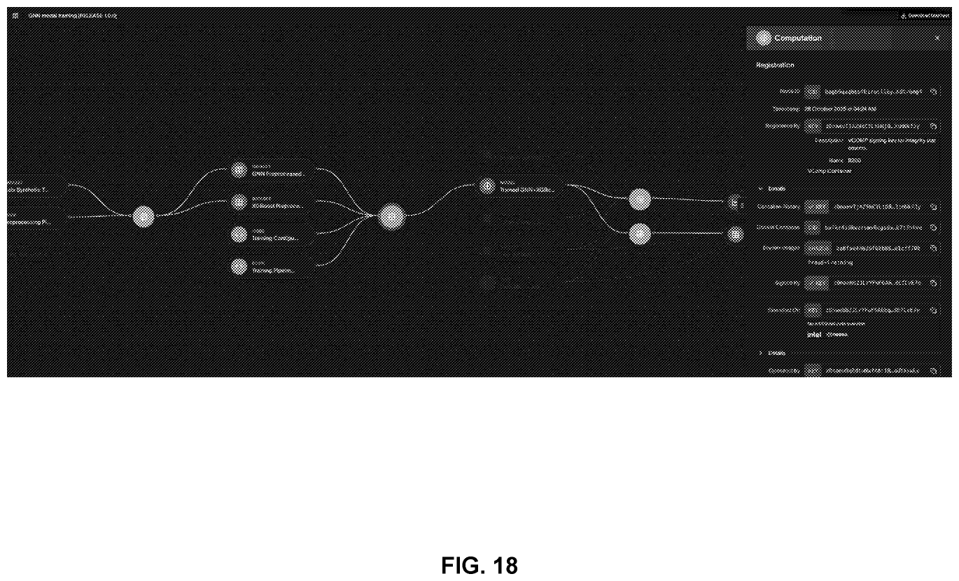

In addition to viewing governance service states, interface 1338 can also be used to examine statements that are registered into integrity service 1326. An example is shown in FIGS. 17-18, which depict a graph of a data preparation pipeline with training and hardware attestations. In particular, data shown in FIGS. 17-18 is provided by an explorer application embedded into governance studio 1332. The graph shown in FIG. 17 represents a collection of statements generated by integrity SDK 1324. As an example, verifiable runtime 1312 is spun up, and has a Docker workload (e.g., customer software) instrumented with the integrity SDK. As the workload is executed, the integrity SDK generates a set of statements which get bundled into a manifest, and registered to integrity service 1326. The manifest can be rendered using the explorer application (e.g., included as part of verification stack 1344). Nodes in the graph depicted in FIG. 17 generally comprise a plurality of statements. As an example, node 1702 represents a compute node. It has two inputs (1704, 1706) and two outputs (1708 and 1710). If a user were to click on node 1702, they'd see the following JSON documents describing the relationship and attested by the verifiable compute notary:
{“@context”: “urn:cid:bafkr4ieddazlnl77lxwrygp5ky2sabfdpcowgrdr2nthd6hkhr2vcxciry”,
“@id”: “urn:cid:bagb6qaq6ebssjgjs3vmrsin6rs7xbxcwa4hiyjwnsdgf4wgy5siuhchao6ve6”,
“@type”: “ComputationRegistration”,
“executedOn”: “did:key:zDnaebb2JLrYFwFGA6EqoMu5Uh1bxTUQ8KKbToYh18EfCvE7e”,
“input”: [
“urn:cid:bafkr4icqw77khu73vgw74jpnlnep37ec3l6jd4lg5kvw2letvqjhyk6jmi”,
“urn:cid:bafkr4iakgcxuxrsoml2hnbn5lckm3ok6bumu2vcsnfxiqofqphxvw5ntg4”
],
“operatedby”: “did:key:zDnaeuQEdtwNwfA8r1BFjjdics95kAKLHxjcQt35aUYXswLv”,
“output”: [
“urn:cid:bafkr4idv3ixo6fvwsfmpcan6d4lpiau7ommexms5u24mwzsfbibsbtcsjy”,

“urn:cid:bafkr4iazko47gsjrdai3jnzv2624s3i3y6gijtrvpippkclbjzzl2gbnkke”
],

“registeredBy”:
“did:key:zDnaepHSWPGUx5BVzJTMcqo7k5qjSDWNm1LudDy4hQBHpEKmY”,
“timestamp”:“2025-10-26T04:16:25Z”
}
{
“@context”: [
“https://www.w3.org/ns/credentials/v2”,
“https://w3id.org/security/v2”
],
“id”: “urn:uuid:42a548b1-2772-479b-881d-7d351c1c19fd”,
“type”: [
“VerifiableCredential”
],
“credentialsubject”: {
“id”:“urn:cid:bagb6qaq6ebssjgjs3vmrsin6rs7xbxcwa4hiyjwnsdgf4wgy5siuhchao6ve6”
}
“issuer”: “did:key:zDnaepHSWPGUx5BVzJTMcqo7k5qjSDWNm1LudDy4hQBHpEKmY”,
“issuanceDate”: “2025-10-26T03: 16:25Z”,
“proof”: {
“type”: “EcdsaSecp256r1Signature2019”,
“proofPurpose”: “assertionMethod”,
“verificationMethod”:
“did: key:zDnaepHSWPGUx5BVzJTMcqo7k5qjSDWNm1LudDy4hQBHpEKmY #zDnaepHSW PGUx5BVzJTMcqo7k5qjSDWNm1LudDy4hQBHpEKmY”,
“created”: “2025-10-26t03: 16:25z”,
“jws”:
“eyJhbGciOiJFUzI1NiIsImNyaXQiOlsiYjY0Il0sImI2NCI6ZmFsc2V9.iSdQnYZxMO9mvWZz 9yTWIiPXFxvLgpIpDFIoxOHyU-XBFV11pa0TVKcT1qd87fQ_bG0bh0ovS4lSV-aaary-5Q”
},
“validfrom”: “2025-10-26T03:16:25z”

### }

Note that the statement has two input hashes and two output hashes, which correspond to the two input and two output nodes in the graph. Nodes 1704 and 1708 are data nodes which represent datasets. If the user clicked on node 1708, they would see the following JSON documents describing the data integrity and attested by the verifiable compute notary:
{
“@context”: “urn:cid:bafkr4ieddazlnl77lxwrygp5ky2sabfdpcowgrdr2nthd6hkhr2vcxciry”,
“@id”:“urn:cid:bagb6qaq6edomxzx4kl32tayyrtp3ynsicu2qiwuq5z7efrbz2nzsnf4r4un66”,
“@type”: “DataRegistration”,
“data”: “urn:cid:bafkr4idv3ixo6fvwsfmpcan6d4lpiau7ommexms5u24mwzsfbibsbtcsjy”,
“registeredBy”: “did:key:zDnaemnFYatjruBkgB2LAZQWC41f1vEFg8daPoPSth3gpGxW7”,
“timestamp”: “2025-10-26T04:19:02Z”
}
{
“@context”: [
“https://www.w3.org/ns/credentials/v2”,
“https://w3id.org/security/v2”
],
“id”: “urn:uuid: 3ccda715-915f-47da-bb39-1172d0a1e1f5”,
“type”: [
“VerifiableCredential”
],
“credentialsubject”: {
“id”: “urn:cid:bagb6qaq6edomxzx4kl32tayyrtp3ynsicu2qiwuq5z7efrbz2nzsnf4r4un66”
},
“issuer”: “did:key:zDnaemnFYatjruBkgB2LAZQWC41f1vEFg8daPoPSth3gpGxW7”,
“issuanceDate”: “2025-10-26T03:19:02Z”,
“proof”: {
“type”: “EcdsaSecp256r1Signature2019”,
“proofPurpose”: “assertionMethod”,
“verificationMethod”:
“did:key:zDnaemnFYatjruBkgB2LAZQWC41f1vEFg8daPoPSth3gpGxW7#zDnaemnFYatjruBk gB2LAZQWC41f1vEFg8daPoPSth3gpGxW7”,
“created”: “2025-10-26T03:19:02z”,
“jws”:
“eyJhbGciOiJFUzI1NiIsImNyaXQiOlsiYjY0Il0sImI2NCI6ZmFsc2V9.XwSvR1cUzS1Su1QBO qJ-KRqGAOPIHwxuCjr9f0ohEzkKGY5YWwzCAuV-wMMcdJWCou1ICQAFZLs6HhnclsdUeg”
},
“validfrom”: “2025-10-26T03:19:02z”

### }

Node 1710 represents a document node. By clicking on node 1710, the user can view the document, an excerpt of which is reproduced below. As mentioned above, data blobs can be embedded in manifests, and this is an example of such a data blob. The particular document is titled “Synthesis Evaluation Report” and is stored in the text format (and corresponds to an HTML report). If desired, the user can view the document as rendered as HTML instead of/in addition to viewing the raw text.
<!DOCTYPE html>
<html lang=”en”>
<head>
<title>NeMo Safe Synthesizer Evaluation Report</title>
. . .
body {
font-family: “Helvetica Neue”, Arial, sans-serif;
font-weight: 300;
min-height: 100 vh;

Returning to FIG. 13, enforcement stack 1308 is also located on customer premise. Enforcement uses verification libraries (e.g., via enforcement SDK 1340) to perform cryptographic validation, check hardware attestations, etc., to ensure that incoming statements are legitimate/have not been tampered with. A set of rulebooks 1342 (implemented, e.g., using Rego) are loaded into components that perform the enforcement.

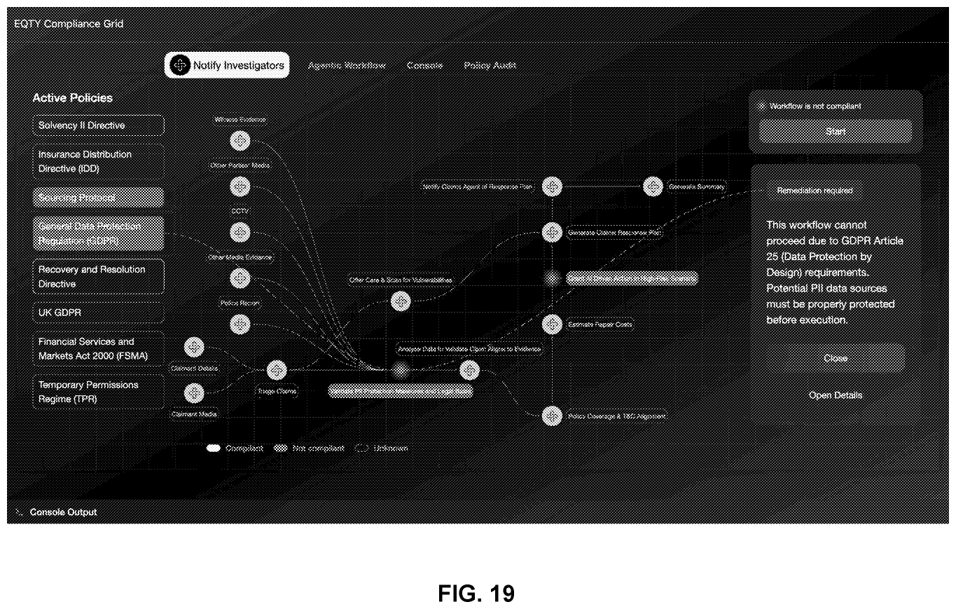

In an example use scenario of a multi-agent workflow (described in more detail below), multiple agents in an example data flow are collaborating with one another. Each of the agents issues statements. If a violation is detected at the enforcement layer upon inspection, a gate can stop the multi-agent workflow and generate an alert that a problem was detected. Various remediations can be taken, such as asking for a human override, or shutting down implicated instances. Depending on implementation, enforcement can make use of a variety of control points, such as a virtual router or a virtual firewall within a hyperscaler. In an environment outside of a hyperscaler (e.g., a robotics scenario), other enforcement mechanisms can be used as applicable, e.g., by including the enforcement SDK in an appropriate layer. An example of the identification of a noncompliance in a multi-agent scenario is shown in FIG. 19. Information about the noncompliance is readily surfaced to a user of the interface. In the example of FIG. 19, several organizational policies are deployed. In the areas flagged, it is determined that when data travels from one location to another—from one agent to another—the transfer could run afoul of such policies. In a multi-agent workflow, it is desirable for agents to be able to prove to one another (and the overall system/any other appropriate interested parties) that the work they perform is legitimate. If the agents are approved actors in an ecosystem and a policy-driven check fails, remediation occurs—e.g., by terminating the processing or surfacing the problem to a human who can be asked to review/resolve the situation. In some scenarios, the problem can also be surfaced to other agents to resolve (e.g., those tasked with addressing such issues).

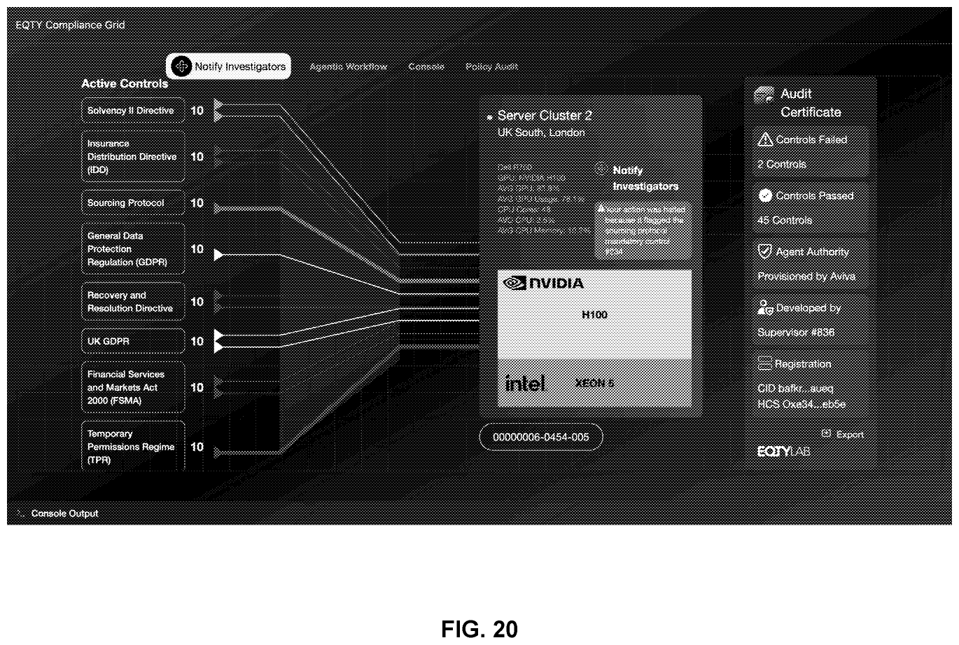

FIG. 20 illustrates the tracing of attestations to hardware showing that the statements themselves are ultimately originated from Intel and NVIDIA hardware attestations. By implementing the SDK in multiple agents and then running the agents on verifiable hardware, a high assurance can be given that the agents are executing the code that the agents are expected to be executing on also that their behavior is being captured. Enforcement layers can watch (e.g., via a subscription) to the stream of events through backend services, or as applicable, peer-to-peer. As an example, it is possible for one agent to provide a statement to another agent without it passing through a backend. Applicable governance rules can be enforced in between the agents and also at the agent layers.

### Example Application: Multi-Agent Computing

When a human user interacts with an LLM, the user typically sends a prompt, receives a reply from the LLM, sends an additional prompt, receives an additional reply, and so on, with the context growing over time. An “agent” can be thought of as a system that has an agent harness that has access to an LLM and/or access to a variety of other tools. The tools can be native, can require Internet access, can be Model Context Protocol (MCP) based tools, etc. In a given scenario, the agent harness makes a plan and then it executes the plan by accessing tools to get additional information to fill in the context window, to send it back to the LLM for more sophisticated prompts, and eventually arrive at the results. In short, the agent harness can mimic or approximate workflows which a human might otherwise perform. In an example scenario, a human researcher might periodically perform academic paper searches for materials, collect data from a variety of sources, synthesize the data, perform updated searches, etc. These tasks (e.g., “stay up to date on topic X,” “contact other researchers with relevant questions,” “incorporate any changes into my thesis,” etc.) are examples of tasks that agent can also perform (e.g., as orchestrated by an agent harness). As described in more detail below, in some scenarios, a given agent may work with another agent (or set of agents) to perform tasks. When an agent communicates with another agent (e.g., a first agent provides a prompt to a second agent), this is generally referred to herein as an “agent-to-agent” communication. As will be described in more detail below, unique problems can arise with agent-to-agent communications. One fundamental problem stems from an erroneous assumption that multiple agents in communication with one another share a progeny. A first agent authored by/running on systems vetted by a first entity may potentially be trusted to interact with a copy/clone of itself (e.g., recruited to perform sub-tasks). Such trust can be (and is likely highly) misplaced should the first agent interact with another agent provided by a third party (and thus not vetted by other otherwise subject to the operating constraints expected by the first entity). Techniques described herein can help identify and mitigate potential risks associated with use of agent-to-agent communications.

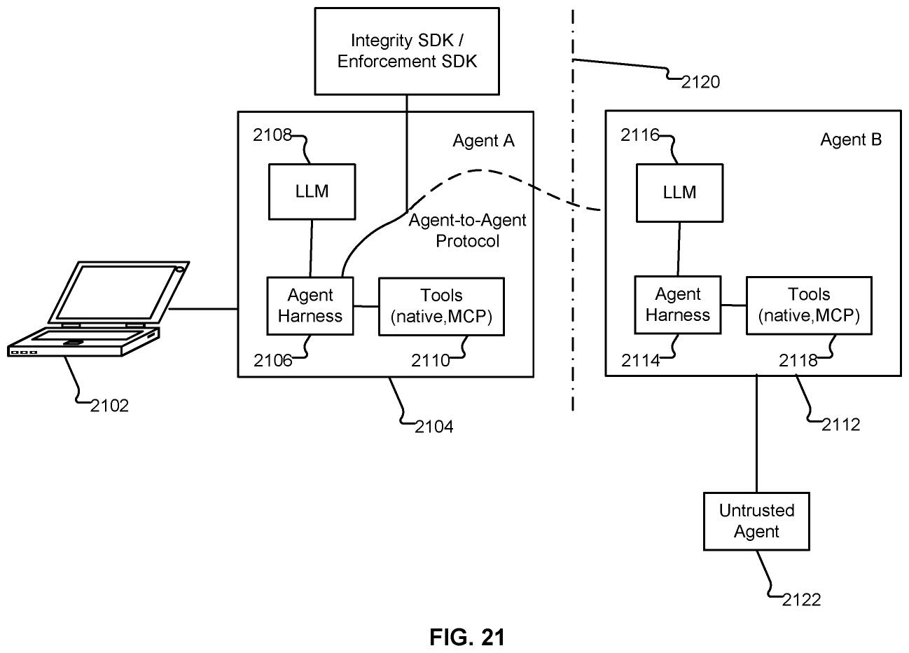

FIG. 21 illustrates an example of an environment in which multiple agents are used. In the example shown, a human user of laptop 2102 (hereinafter also referred to as “Alice”) is accessing a first agent (agent 2104). Agent 2104 could be running locally (e.g., on laptop 2102) but could also be running elsewhere (e.g., accessible via a web page loaded in a browser executing on laptop 2102). As explained above, a given agent harness (e.g., agent harness 2106) can consult with an LLM (e.g., LLM 2108) and can also make use of one or more tools (collectively, tools 2110). As applicable, agent 2104 can recruit additional agents (or sub-agents), whether by spawning them itself (e.g., an additional agent or sub-agent executing on laptop 2102) or contacting them (e.g., a third-party agent).

In the example shown, suppose Alice is a medical researcher performing medical research on behalf of a university (hereinafter ACME University). Agent 2104 is provided by the medical department and leverages an LLM 2108 trained on data at least some of which is confidential/restricted from being used in unapproved manners (e.g., includes patient information). Also depicted in FIG. 21 is a second agent (agent 2112). Agent 2112 is hosted by the medical department of another university (hereinafter Beta University). Agent 2112 has its own respective agent harness 2114, its own LLM 2116 (e.g., trained using materials available to Beta University), and its own set of tools 2118. Agent 2104 can communicate with agent 2112 (e.g., via an agent-to-agent protocol). While the scenario described herein involves two agents provided by two different entities, the techniques described herein are not so limited. For example, the multi-agent techniques herein are usable in a variety of situations, including where agent 2104 instantiates a new sub-agent, talks to a pre-existing one, or potentially writes/revises agent code to build and launch a new custom agent. The techniques are also usable in more complex scenarios (e.g., with many agents, potentially provided by many entities communicating).

Line 2120 represents a “trust boundary.” When Alice uses agent 2104, and agent harness 2106 only makes use of local resources/tools, there is a first degree of trust involved (e.g., that LLM 2108 is a legitimate resource that has not been tampered with, that patient data will be handled appropriately, etc.). If agent 2104 communicates across boundary 2120, the degree of trust almost certainly degrades—potentially quite significantly. One serious concern is that agent 2104 will improperly export confidential data outside of expected boundaries (e.g., beyond what patients have agreed to, and/or any applicable regulatory/other expectations). Another serious concern is the potential that data received back by agent 2104 across boundary 2120 is compromised or otherwise unreliable/harmful. If Alice were directly conducting the research with a colleague, Dr. Bob at Beta University (instead of by using agent 2104), she would likely rely on a checklist or other set of guidelines on how to collaborate appropriately (e.g., after receiving training on how to anonymize data before sharing it, receiving permission from a supervisor for a particular scope of research, etc.). Similarly, she'd have reasonable expectations that her collaborator is reputable (e.g., based on the colleague having an official job at the other university, the colleague having previously collaborated with Alice or people known to Alice, etc.).

One approach to handling trust boundaries is for ACME University to forbid access to any outside agents (e.g., firewalling agent 2104 from communicating across trust boundary 2120 at all). Unfortunately, this hard line approach could prevent Alice from using legitimate tools that could improve the quality of the research she is conducting. As an example, LLM 2116 may have specialized/proprietary knowledge (e.g., the ability to provide highly accurate analyses of particular types of MRI images, or having been trained on data pertaining to a group of patients with a rare disease that visit a specialty clinic at Beta University) that LLM 2108 lacks. In a related scenario, Dr. Bob, as an employee at Beta University may wish to consult with Alice on one of his patients (e.g., to obtain a second opinion). If there is a complete prohibition on communications between agents 2104 and 2112 (e.g., as enforced by ACME University), mundane tasks such as billing or scheduling joint meetings (which agents could be particularly useful for), or tasks for which a patient has explicitly given consent (e.g., the sharing of lab results for the purpose of obtaining a second opinion) would have to be performed manually—potentially wasting a great deal of time and resources unnecessarily.

As mentioned above, one problem with multi-agent scenarios is the potential that data received from a third-party agent may be unreliable. Of note, the data need not have been maliciously compromised to cause problems. As an example, suppose Bob's agent (2112) relies on a third party model to perform one aspect of medical record analysis. Unbeknownst to Bob (and anyone else at Beta University), the third party model gets “upgraded” by its maintainer and the new version hasn't been validated regarding medical record analysis. Weeks or months could go by before it is discovered that the new model performs worse than the previous one. Meanwhile, Bob will be making certain medical conclusions based on the erroneous assumption that the medical record analysis is reliable. Even once the flawed model update is identified, it can be difficult to ascertain which specific reports made use of the flawed model (e.g., to identify patients who need their records re-evaluated). In this scenario, none of the actors are participating with ill-intent, and it might be possible to use metadata to identify which reports should be flagged. The situation is exacerbated if any malfeasance was involved (e.g., metadata is forged), potentially making it impossible to determine which records were processed as expected and which were not.

Using techniques described herein, aspects such as recordkeeping, compliance, and real-time validation can be used to help allow users to gain the benefits of multi-agent computing, while also helping protect against unwanted outcomes. As with other kinds of verifiable computing, proofs associated with agents can be generated and aggregated into a database, whether for recordkeeping, real-time enforcement, or other purposes. Using techniques described herein, for example, if a problem is detected in real-time, actions can immediately be taken to mitigate harm. Further, if problems are only subsequently detected, techniques such as cryptographically verifiable auditing can be used to help in remediation. Gates can be deployed between agents so that when a first agent contacts a second, checks can be made, for example, to determine whether the request is from a legitimate originator (e.g., a university hospital employee with appropriate credentials). Further, as discussed throughout, a variety of decisions can be made at the gate, such as allowing the communication, generating an alert, terminating the communication, terminating the workflow, pausing the workflow until an additional input is received (e.g., from an administrator), or causing a different agent to be involved in the communication (whether as the originator or receiver of the request).

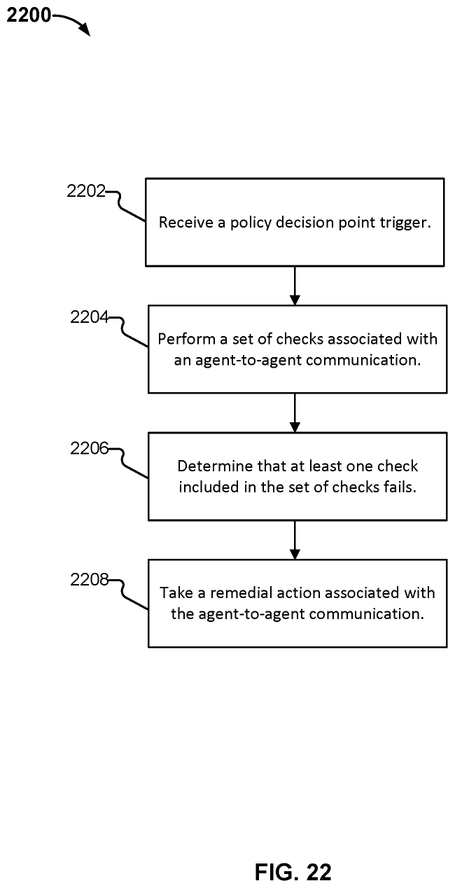

FIG. 22 is a flow chart illustrating an embodiment of a process for evaluating an agent-to-agent communication. In various embodiments, the process is performed by system 1300 or portions thereof.

As mentioned above, an entity (e.g., ACME University) using techniques described herein could configure a set of rulebooks 1342 that define a set of rules to be enforced. Examples of rules include policies describing interactions that an agent such as agent 2104 can have with agents outside of the university's control (e.g., agent 2112). Rules can be custom created (e.g., by university hospital personnel) and can also be imported (e.g., as a set of GDPR or HIPAA pre-built rules). Enforcement can be performed at a gateway (e.g., supervising university network traffic) and can also be performed, for example, inside the agent itself, e.g., if enforcement SDK 1340 or portions thereof are incorporated into agent 2104 or another appropriate place.

One example of a rule that could be included in rulebooks 1342 is that any agent-to-agent communications between agent 2104 and agent 2112 occur using a predetermined set of IP address ranges and encrypted using a particular protocol (with no option for fallback if a secure connection cannot be established). Another example is a rule that instructs agent 2104 to ignore any incoming requests if they are not signed with a key that belongs to a trusted hospital partner with which there is a billing arrangement. Beta University may or may not implement its own instance of integrity SDK 1324 and enforcement SDK 1340. Accordingly, Beta University may or may not allow its agent 2112 to communicate with other third party agent (e.g., agent 2122). Relatedly, assuming Beta University also implements techniques described herein, agent 2104 (via ACME's instance of governance studio 1348) could enforce requirements that any data provided by agent 2112 (e.g., analysis an MRI) to agent 2104 have its work be verifiably signed (and subject to any other requirements, such as use of a particular version of tool executing on particular secure hardware). This would allow ACME to filter out the possibility of results generated by agent 2122 to be forwarded to agent 2112 and then further forwarded to agent 2104. As another example, if Beta University also uses an instance of enforcement SDK 1340, it could enforce a rule requiring any MRI images submitted by outside agents (e.g., agent 2104) be generated by machines of a particular brand, model number, firmware version, etc. (e.g., ones for which Beta University's LLM 2116 analysis is known to perform well), so as to not return unreliable results when other brands of MRI are submitted. Example ways of confirming such information include by using a manufacturer provided signature, examining a file signed by the MRI machine, and/or checking for specific versions of firmware using hashes.

Another example of rules that can be included in rulebooks 1342 pertain to proof of confidentiality data privacy requirements. As an example, ACME University could enforce a rule that its MRI data be processed by Beta University only in a confidential environment so that employees at Beta University don't have access to identifiable patient data (i.e., only LLM 2116 has access to the data, and LLM 2116 generates results without the data needing to be read in an open compute environment). In various embodiments, agent 2104 incorporates a verification SDK (e.g., provided by verification stack 1344) to perform verifications of statements made by agent 2112. Verification can also be performed elsewhere, as applicable, such as by a gateway provided at ACME.

Process 2200 begins at 2202 when a policy decision point trigger is received. The policy decision point can be built into a gateway as a separate component (e.g., between ACME and Beta) but can also be built into agents themselves. As discussed above, enforcement stack 1308 makes use of a set of rulebooks 1342 to evaluate statements (proof). Data arriving into the policy decision point is matched against policies defined in governance studio 1332 and evaluated inside enforcement mechanism 1308. If this enforcement component implemented as gateway, then traffic arrives and is matched against the policies that are deployed to the gateway. If the enforcement is implemented within agents themselves, matching is performed in the agents.

In an example scenario, assume Alice begins working on a Monday morning by logging into her laptop 2102. After doing initial tasks such as web browsing and checking her email, she decides to investigate whether patients with a first condition are more or less likely than patients with a second condition to have allergic reactions to a particular pharmaceutical compound. She initially uses agent 2104 to investigate via LLM 2108. At this point, agent 2104 might encounter a policy decision point trigger (e.g., confirming that she is a legitimate user in good standing at the University before granting access). Suppose that agent harness 2106 determines that agent 2122 should be consulted. At this point, at 2202, another policy decision point trigger is reached—this time requiring that the request agent 2104 intends to make of agent 2122 is permissible.

At 2204, a set of checks associated with the agent-to-agent communication is performed at ACME. In this scenario, agent 2122 is an untrusted agent. As discussed above, performing such checking includes evaluating statements/digital signatures to ascertain that the evidence is authentic (e.g., information in fact originated from the claimed source, was handled by a confidential computer as applicable, etc.). Hardware attestations can also be checked, as required by enforcement policies where applicable.

At 2206, it is determined that one or more checks included in the set fails. Examples of checks that could be determined to fail include: agent 2122 does not offer a digital signature associated with a hospital for which ACME has a billing agreement, agent 2122 is not reachable via a particular IP address, agent 2122 is hosted at a location that is not preapproved, etc. Other examples of checks that could be determined to fail include ones directed at agent 2104 (e.g., in the event agent harness 2106 attempts to transmit unredacted patient files across boundary 2120, or attempts to silently install or uninstall software on laptop 2102).

Finally, at 2208, a remedial action associated with the agent-to-agent communication is taken. As one example, an alert can be generated and the workflow paused until a human intervention is received. An administrator or other appropriate person (e.g., Alice or Alice's supervisor) can review the alert and determine whether, e.g., the ruleset should be revised (e.g., to allow the communication in the future), whether the ruleset should be left as is and the workflow resumed (or terminated), etc. Another agent could also be tasked with making the determination (e.g., one trained extensively regarding data safety practices/requirements). As another example, any connections between the agents can be terminated. As yet another example, at least one agent can be shut down. As yet another example, a different agent can be asked to process the request (i.e., step in for one of the participants). In one example, instead of attempting to obtain information from agent 2122, agent 2104 can be instructed to obtain information from agent 2112. In another example, instead of having agent 2104 communicate with agent 2122, a different agent (e.g., one without access to confidential patient information) can be used to, e.g., request information. Further, even in the event the checks performed at 2204 all succeed (i.e., no rules are determined to have been broken), system 1300 can nonetheless be used to log verifiable transaction information. This would allow, for example, for the University to respond to audit requests regarding their privacy practices.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a policy decision point trigger;
performing a set of checks associated with an agent-to-agent communication;
determining that at least one check included in the set of checks fails; and
taking a remedial action associated with the agent-to-agent communication.

2. The method of claim 1, wherein performing the set of checks includes examining at least one signed statement in a verifiable compute manifest external to a trusted environment.

3. The method of claim 1, further comprising:
providing a signed attestation of a trusted computing environment based at least in part on a hardware-based cryptographic key, wherein a notary key is signed using the hardware-based cryptographic key.

4. The method of claim 3, wherein the signed attestation includes a representation of the trusted computing environment.

5. The method of claim 4, wherein the representation of the trusted computing environment includes a hash of a virtual machine file system of the trusted computing environment.

6. The method of claim 4, wherein the representation of the trusted computing environment includes a hash of a Docker image of the trusted computing environment.

7. The method of claim 3, wherein the hardware-based cryptographic key is associated with a hardware trusted execution environment of the trusted computing environment.

8. The method of claim 1, further comprising generating a notary key of a trusted computing environment.

9. The method of claim 1, wherein taking the remedial action includes prompting an administrator for an override.

10. The method of claim 1, wherein taking the remedial action includes terminating the agent-to-agent communication.

11. The method of claim 1, wherein taking the remedial action includes terminating at least one agent involved in the agent-to-agent communication.

12. A system, comprising:
a processor configured with a trusted computing environment; and
a memory coupled to the processor, wherein the trusted computing environment protects the memory from unauthorized access, and wherein the memory is configured to provide the processor with instructions which when executed cause the processor to:
receive a policy decision point trigger;
perform a set of checks associated with an agent-to-agent communication;
determine that at least one check included in the set of checks fails; and
take a remedial action associated with the agent-to-agent communication.
